(19) United States
(12) Patent Application Publication
(10) Pub. No.: US 2026/0150843 A1
(43) Pub. Date: Jun. 4, 2026

(54) NOVEL CROP NUTRITION COMPOSITION

(71) Applicant: Komal BHUKHANWALA, Mumbai (IN)

(72) Inventor: Komal BHUKHANWALA, Mumbai (IN)

(21) Appl. No.: 19/126,195

(22) PCT Filed: Nov. 6, 2023
(86) PCT No.: PCT/IN2023/051023

§ 371 Date: Apr. 30, 2025

(30) Foreign Application Priority Data
Nov. 4, 2022 (IN) 202221063210

(51) Int. Cl. A01N 59/02; A01N 25/14; A01N 25/30; A01N 59/16; A01P 21/00

(52) U.S. Cl. CPC A01N 59/02; A01N 25/14; A01N 25/30; A01N 59/16; A01P 21/00

(57) ABSTRACT

The invention particularly relates to a crop nutrition and fortification composition comprising elemental sulphur in the range of 1% to 90% by weight of the total composition; one or more of zinc in the form of water insoluble salts, complex or derivative thereof wherein the content of elemental zinc in the composition is in the range of 0.10% to 50% by weight of the total composition; elemental selenium or its salts, complexes, derivatives or mixture thereof wherein the elemental selenium content is in the range of 0.0010% to 10% by weight of the total composition; and at least one surfactant in the range of 0.1% to 40% w/w of the total composition; wherein the composition has particles in the size range of 0.1 micron to 30 microns and wherein the composition is in the form of granules or aqueous suspension. The present invention also relates to process of preparation of the crop nutrition and fortification composition. The invention further relates to a method of enhancing nutrient uptake and improving the plant health and yield by treating a plant, plant propagation material, locus or parts thereof, a seed, seedling or surrounding soil with the crop nutrition and fortification composition.

### FIELD OF THE INVENTION

The present invention relates to a crop nutrient and fortification composition comprising elemental sulphur; one or more of water insoluble zinc salts, complexes or derivatives thereof; elemental selenium or its salts, complexes, derivatives or mixture thereof; and at least one surfactant; wherein the composition has particles in the size range of 0.1 to 30 microns. More particularly, the invention relates to a crop nutrition and fortification composition in the form of granules or aqueous suspension comprising elemental sulphur in the range of 1% to 90% by weight of the total composition; one or more of water insoluble zinc salts, complexes or derivatives thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition and at least one surfactant in the range of 0.1% to 40% by weight of the total composition; wherein the composition has particles in the size range of 0.1 micron to 30 microns.

The invention further relates to a method of enhancing nutrient uptake and improving the plant health and yield by treating a plant, crop, plant propagation material, locus or parts thereof, a seed, seedling or surrounding soil with the crop nutrition and fortification composition of the present invention.

The invention furthermore relates to use of the composition of the present invention for improving uptake of sulphur, selenium and zinc by the crops.

### BACKGROUND OF THE INVENTION

In describing the embodiment of the invention, specific terminology is chosen for the sake of clarity. However, it is not intended that the invention be limited to the specific terms so selected and it is to be understood that each specific term includes all technical equivalents that operate in a similar manner to accomplish a similar purpose.

It is known that optimum levels of nutrients are required for the normal functioning, and growth of the plants, and any variance in the nutrient levels may cause hindrance in overall crop growth and cause its health to decline due to either a deficiency or toxicity in turn affecting the nutrients essential for human diet. Furthermore, poor availability of nutrients to the plants also results in a lack of proper growth, resulting in the plants becoming more susceptible to attack by pests. Therefore, proper crop nutrition is critical for optimizing crop development and metabolism, which in turn contributes for improving the crop yield and the quality of the produce.

In parallel, it is well known that plants as source of food for humans and animals, provide nutrients which are necessary for regulating biochemical functioning of the body. Deficiency of nutrients substantially contribute to the global burden of diseases.

Selenium is the trace elements which is not considered to be essential for plants however, it is an indispensable trace nutrient required for balanced nutrition in animals and humans. Selenium (Se) is an essential trace mineral, constituent of the selenoproteins responsible for important enzymatic functions. The function of selenoproteins in the human metabolism is most commonly connected to immune competence and cancer prevention. In addition it also plays an important role in fertility and reproduction, brain functions, mood, thyroid health, and cardiovascular diseases (Rayman, M. P. Selenium and human health. Lancet 2012, 379, 1256-1268). Selenium deficiency affects 500 million to 1 billion people worldwide due to inadequate dietary intake (NDA/BLA Multi-disciplinary Review and Evaluation NDA 209379, US FDA). Deficiency of selenium in humans have been linked to several kinds of cancer, heart disease and other chronic and life-threatening conditions (Gupta et. al, Selenium in soils and crops, its deficiencies in livestock and humans: Implications for management, Communications in Soil Science and Plant Analysis, 31:11-14, 1791-1807, 2000).

Inadequate dietary selenium intake has been estimated to affect up to 1 billion people worldwide and is also known to affect livestock health adversely. The main source of selenium for human food as well as animal fodder is the soil-plant system, since dietary Se intake depends largely on Se content in soil and bioavailability to crops. Rainfall, evaporation, and pH levels all affect selenium concentration in soil and this makes selenium deficiency more common.

Zinc (Zn) is essential for maintaining the structure and activity of many enzymes, besides playing a key role in the synthesis of nucleic acids and proteins. Zinc deficiency affects approximately 2 billion people worldwide and results in more than 0.5 million deaths per year in infants and children below 5 years of age due to inadequate dietary intake (Ahsan Ak et. al., Zinc Micronutrient Deficiency and Its Prevalence in Malnourished Pediatric Children as Compared to Well-Nourished Children: A Nutritional Emergency. Glob Pediatr Health. 2021 Oct. 8).

Zinc is also essential in plant metabolism, as it plays a key role in chloroplast development and function. Although most of the world's cultivated soils contain enough Zn to sustain its accumulation in plants' edible portions, Zn phyto-availability is a factor often limiting its uptake by roots, and it has been estimated that about one-fifth of the world's population suffers from Zn deficiency (White, P. J.; Pongrac, P.; Sneddon, C. C.; Thompson, J. A.; Wright, G. Limits to the biofortification of leafy brassicas with zinc. Agricultures 2018, 8, 32).

Though the benefits of these nutrients are well known, their deficiency has become widespread over the past several decades in most of the agricultural areas of the world resulting in these nutrients being indicated as a limiting factor to improve plant growth, high yield and fertilizer efficiency. The reasons for deficiency of these nutrients are:
Severe imbalance of soil pH caused due to excessive and indiscriminate application of chemical fertilizers like urea, DAP etc.
Environmental conditions such as drought, biotic and abiotic stress, soil health.
Nutrient antagonism due to indiscriminate use of multiple macronutrients, secondary macronutrients, micronutrients and trace nutrients in fertigation.

Both poor and inadequate availability of these nutrients in soil impacts plant metabolism resulting in poor growth or lack of plant physiological development. As a consequence, plants become more susceptible to diseases and attack by pests. Deficiency of these nutrients in plants also impacts animal and human health.

Further, Sulphur (S) is an essential plant nutrient, long known for its role as a fertilizer. Deficiency of sulphur has become widespread over the past several decades in most of the agricultural areas of the world, resulting in sulphur being indicated as a limiting factor to high yields and fertilizer efficiency. One of the reasons of growing Sulphur deficiency in recent times being global guidelines towards usage of desulphurized fuel to meet strict emission standards resulting in lack of replenishment of soil sulphur which was earlier met to a large extent on account of presence of atmospheric sulphur being delivered in the form of rain water. The other reasons for deficiency of sulphur are unavailability of sulphur in assimilable form to the plants, loss of sulphur caused by leaching and soil pH, and insolubility of elemental sulphur in water.

Thus, optimizing the soil condition and managing the use of crop nutrients has been a long-felt need for farmers to improve the nutrient use efficiency of crops. However, it is a challenging task to meet the food requirements both in terms of quantity and nutrient content and yet provide better economic return to farmers. Significant research is being carried out so as to improve soil and plant health, provide better economic returns to farmers, and reduce the burden on the environment because of rampant use of conventional fertilizers and synthetic pesticides.

Biofortification of the crops proposes a promising strategy to increase the content of specific nutrients. However, the interaction among different types of plant nutrients is quite complex and it can either be antagonistic or synergistic depending upon the mixture of elements/nutrients and its composition, concentration etc. and that may influence nutrient use efficiency. Due to application of excess nutrients, plants may suffer from “nutrient antagonism” whereby an excess of a particular element may block the absorption of another element required by the plant and it can happen with elements of a similar size and charge (positive or negative) which can result into deficiencies in the plant. For instance, Antagonistic interactions/competitive nature of sulphur and selenium for plant uptake has been reported (Barak et. al, J. Agric. Food Chem. 1997, 45, 4, 1290-1294; Murphy, et.al, (1997); The Effect of Sulphur/Nitrogen/Selenium Interactions on Herbage Yield and Quality. Irish Journal of Agricultural and Food Research, 36(1), 31-38). This can be because of similar chemical and physical properties of Se and S, due to which S can be substituted with Se in the metabolism of plants. This leads to their competition in the uptake, transport, and assimilation in plants. In addition, antagonistic nature of Se and micronutrients when combined together has also been reported (The effects of selenium and other micronutrients on the antioxidant activities and yield of corn (Zea mays L.) under drought stress Nour Ali Sajedi & Mohammad Reza Ardakani & Hamid Madani & Ahmad Naderi & Mohammad Miransari, Physiol Mol Biol Plants (July-September 2011) 17(3):215-222). Further, a review article (Selenium Biofortification and Interaction With Other Elements in Plants, Front Plant Sci. 2020; 11: 586421) reports that nitrate, selenide and selenite ions can antagonize, or compete with, each other's absorption individually and collectively and that high nitrogen applications can reduce Se uptake by plants.

Thus, knowing the varying nature of selenium when combined with other elements, it is difficult to provide the compositions comprising combination of selenium. Further, efficacy of the actives also depends on the types of formulations as well as other components used in the composition. A big problem with several crop nutrients or fertilizers or plant growth promoting products is that they are present in an unusable form when applied and are not sufficiently absorbed by the plants or rapidly penetrate into the soil due to their rapid migration in the soil or their physical form and characteristics. Thus, less nutrients are available to the plant and therefore these products will have less nutrient utilization efficacy.

Several prior arts disclose multinutrient compositions including sulphur, zinc, selenium along with other elements in the form of powder, prills, pellets etc. However, such prior art products are either difficult to apply in the field due to its poor physical characteristics or are not readily available for plant absorption due to which they are not as effective as required. For instance, powder composition not only has issues with respect to a practical application like the generation of dust but also pose risk to the users mostly because of eye irritation, inhalation risk and skin irritation. Further, such formulations have a larger size distribution, resulting in their poorer suspensibility and dispersible and tend to clog the nozzles when applied via drip, making it unsuitable for use in irrigation system. Moreover, these compositions have also been found to have poor suspensibility which lead to random and non-uniform distribution of active ingredient on the target area which would cause undesirable effects and pose a problem in effective delivery of nutrients to the plant or crop, leading to poor uptake of the nutrition by the plants. Owing to such issues, these compositions are also required to be used in large amounts rendering them uneconomical and environmentally unsafe.

CN112321350 discloses soluble fertilizer containing sodium selenite, sulfur as sulphate, manganese sulphate, zinc sulphate, magnesium sulphate, calcium chloride, ammonium molybdate, alkylpolyglycoside, chitosan quaternary ammonium salt for foliar application.

Such type of compositions supplying sulphur in sulphate form viz. calcium sulphate, ammonium sulphate and zinc in water soluble forms viz. zinc acetate, zinc nitrate, zinc sulfate, zinc chloride, zinc chlorate etc. are not found to be very effective since such compositions tend to be leached away during heavy rainfall or irrigation and fail to be absorbed by the plants and this in turn also causes ground water contamination. This results not only in a marked loss of efficiency but also increases the salinity of soil. As soils become more saline, plants are unable to draw as much water and nutrients from the soil entailing the repeated application of fertilizers at higher dosages. This results in serious environmental consequences. Further, selenium when applied at high dosages, is also known to cause toxicity.

CN109453736 discloses multi-component composite attapulgite soil-conditioner obtained by adsorbing sulfur and calcium as calcium sulphate on attapulgite powder and mixing this with silica sol containing selenium and zinc as zinc selenite which is gelled, and granulated and dried to obtain the soil conditioner of the silicon-sulfur-selenium-zinc multi-element composite having silica sol coating over the attapulgite powder.

Such type of granules having silica sol coating can release a small amount of nutrients and trace elements such as silicon, selenium and zinc after high temperature calcination. Since, they are designed in a manner so as to release the actives very slowly and only under high temperature conditions, the actives remain locked in the soil for a prolonged period of time and are not available for the uptake by the plants thus depriving the plant of their immediate nutritional requirement. As a consequence of the nutritional deficiency in the plants during their infancy, it makes them susceptible to various diseases eventually stunting their growth and yield.

In addition, compositions using molten sulphur or prepared by reacting elemental sulphur and sulphuric acid are reported in the art. However, the process of production of such products have number of disadvantages. The most important disadvantage is the fire and explosion hazards. Other problem with such compositions are non-uniformity of the size and shape of the particles of the composition. More than that molten elemental sulphur composition once solidified, do not release sulphur and the intact granules are found in the soil, sometimes even one season after harvesting the crop.

Therefore, there is a need to develop a composition comprising selenium, sulphur and zinc, which would make the said nutrients quickly available to the plant in effective quantities thus meeting the balanced nutritional requirement of plants and addressing the drawbacks associated with prior known compositions. Further, there is a need for an agricultural product that would provide high field efficacy while applying at reduced dosage of application of the composition and the product which would address the other drawbacks discussed above.

The present inventor surprisingly found that the composition of the present invention comprising elemental sulphur in the range of 1% to 90% by weight of the total composition; one or more of water insoluble zinc salts, complex or derivative thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition and at least one surfactant in the range of 0.1% to 40% by weight of the total composition; in the form of granules or aqueous suspension with the particles of the composition in the size range of 0.1 to 30 microns not only exhibited synergistic effect but also effective in addressing the above discussed drawbacks.

The inventor was surprised to note that such superior effects were not observed with a combination of sulphur in sulphate form and water soluble salts or derivatives of zinc, even when formulated in granular form or aqueous suspension form. It was also observed that the composition of the present invention when formulated at a specific particle size further enhances the availability of sulphur, zinc and selenium for uptake by the plants even at initial stage of plant life cycle. It was further surprising to observe that the balanced uptake of nutrients leads to a healthier plant that could withstand pest infestation, a higher nutrient harvest in all soils types and finally improve the overall soil health. The present composition acts as a nutrient-use efficient composition while meeting the need of crops by providing a multi nutritive solution with improved uptake by crops at reduced dosage. The present composition was further observed to prevent the leaching of these nutrients and making them available to the fullest extent for the uptake by crops and increase the overall yield.

It was noted that the enhanced effects in terms of crop yield and uptake of nutrients and growth characteristic were observed when the composition comprised of elemental sulphur and water insoluble salts or derivatives of zinc with selenium in its elemental form or salts or derivatives and formulated in the form of granules or aqueous suspension wherein the composition readily disperses in water or in the presence of soil moisture into fine particles of size range 0.1-30 microns making an immediate availability of nutrients to the plant.

The inventor of the present application has determined that the crop nutrition composition in the form of water dispersible granules, water disintegrable granules or aqueous suspension comprising of elemental sulphur, one or more water insoluble zinc salts or derivatives thereof and one or more selenium salts or derivatives thereof with at least one surfactant; wherein the composition comprises particles in the size range of 0.1 micron to 30 microns demonstrates excellent field efficacy even when applied at reduced dosage of application.

### SUMMARY OF THE INVENTION

The present invention relates to a crop nutrition and fortification composition comprising elemental sulphur; one or more of water insoluble zinc salts, complexes or derivatives thereof; elemental selenium or its salts, complexes, derivatives or mixture thereof; and at least one surfactant; wherein the composition comprises particles in the size range of 0.1 micron to 30 microns.

The present invention relates to a crop nutrition and fortification composition comprising elemental sulphur in the range of 1% to 90% by weight of the total composition; one or more of water insoluble zinc salts, complexes or derivatives thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition; and at least one surfactant in the range of 0.1% to 40% by weight of the total composition; wherein the composition comprises particles in the size range of 0.1 micron to 30 microns and wherein the composition is in the form of granules or aqueous suspension.

The present invention further relates to a process for preparation of the crop nutrition and fortification composition in the form of granules, or aqueous suspension comprising elemental sulphur in the range of 1% to 90% by weight of the total composition; one or more of water insoluble zinc salts, complexes or derivatives thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition; and at least one surfactant in the range of 0.1% to 40% by weight of the total composition; wherein the composition has particles in the size range of 0.1 micron to 30 microns.

The present invention also relates to a method of enhancing the nutrient uptake and improving the plant health and yield by treating a plant, crop, plant propagation material, locus or parts thereof, a seed, seedling or surrounding soil with the crop nutrition and fortification composition in the form of granules or aqueous suspension comprising elemental sulphur in the range of 1% to 90% by weight of the total composition; one or more of water insoluble zinc salts, complex or derivative thereof wherein the content of elemental zinc in the composition is in the range of 0.10% to 50% by weight of the total composition; elemental selenium or its salts, complexes, derivatives or mixture thereof wherein the elemental selenium content is in the range of 0.0010% to 10% by weight of the total composition; and at least one surfactant in the range of 0.10% to 40% by weight of the total composition; wherein the composition comprises particles in the size range of 0.1 micron to 30 microns.

The present invention further relates to a method of treating plants and meeting their nutritional requirement by making nutrients like sulphur, zinc and selenium available to them.

### DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described herein below, the phrase comprising may be replaced by the phrases “consisting of” or “consisting essentially of” or “consisting substantially of”. In these aspects or embodiment, the composition described includes or comprises or consists of or consists essentially of or consists substantially of the specific components recited therein, to the exclusion of other ingredients or excipients not specifically recited therein.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. Any numerical values, however, inherently contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Also, unless denoted otherwise, percentages of components in a composition are presented as weight percent.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The term “plant” or “crop” used in this invention are interchangeable and wherever the term “plant” has been used shall also mean vegetation of similar nature namely crops, trees, shrub, herb etc. The term ‘plant’ refers to all physical parts of a plant, including seeds, seedlings, saplings, roots, tubers, stems, stalks, foliage, and fruits. The term plant includes transgenic and non-transgenic plants.

The term “locus” of a plant herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “Sulphur” used in the composition refers to elemental sulphur (S°) obtained through natural sources or synthetic sources. The term includes allotropes of elemental sulfur such as plastic (amorphous) sulfur, monoclinic sulfur, rhombic sulfur composed of S8 molecules, and other ring molecules such as S7 and S12. The term also comprises sulphur produced through processing and refining of petrochemicals. The term also comprises ‘biosulfur’. The term also comprises elemental Sulphur produced through microbial processes.

Selenium refers to elemental selenium, or selenium in the form of its salts, derivatives or complexes thereof.

Zinc refers to zinc in the form of its salts, derivatives or complexes thereof.

The term ‘derivatives’ used in this application shall also encompass the minerals and ores containing the minerals of selenium and zinc. The term derivatives shall also encompass compounds from which selenium and zinc can be obtained in a form that is assimilable by the plants.

The term ‘salts’ used in this invention shall also encompass the compounds containing zinc, selenium. The compounds of Zinc include Zinc oxide and the compounds of selenium include selenium dioxide.

As described herein, “WG” or “WDG” refer to water dispersible granules and are defined as a formulation which disperses or dissolves rapidly when added to water to give a fine particle suspension. Water-dispersible granules are formulated as small, easily measured granules (an agglomeration of fine particles) by blending and agglomerating ground active ingredients together with surfactants and other formulation excipients which disperses into finer/primary particles upon addition to water. The water-dispersible granules are obtained by spray drying or by extrusion process.

“Quick release” or “instant release” or “instantaneous dispersion” can be used interchangeably and is applicable to granules which rapidly disperse to release the nutrients.

As described herein the term “GR” refers to “water disintegrable granules” and are defined as a granular composition comprising agglomerated granules or particles which upon contact with sufficient water or soil moisture disintegrate or break into individual particles releasing the actives instantaneously and also over a longer period which may extend throughout the crop cycle.

As defined herein, the term “aqueous suspension” is a composition wherein solid particles are dispersed or suspended in a liquid. The term “suspension concentrates” or “aqueous suspension” or aqueous dispersion” or “an SC composition” can be used interchangeably.

A mixture is defined as a combination of two or more substances that are not chemically united to each other. A homogeneous mixture is defined as one whose composition is uniform throughout the mixture. It is the type of mixture where the composition is constant throughout or the components that make up the mixture are distributed uniformly.

Further, the active dosage of active in a composition applied in the field experiment is of elemental active.

Nutrient use efficiency (NUE) is defined as a measure of how well plants use the available mineral nutrients. Improvement of NUE is an essential pre-requisite for expansion of crop production into marginal lands with low nutrient availability but also a way to reduce use of inorganic fertilizer.

The particle size of the composition is defined as the particle of size of the composition in the form of water dispersible granules or water disintegrable granule or aqueous suspension as a whole comprising elemental sulphur, zinc, selenium and excipient. D50 is the corresponding particle size when the cumulative percentage reaches 50%. D50 is also called the median particle diameter or median particle size and represent an average 50% of the total particles to be smaller than the determined size. D90 is used to indicate particle size distribution and represent average 90% of the total particles to be smaller than the determined size. D90 is also the corresponding particle size when the cumulative percentage reaches 90%.

The present invention relates to a crop nutrition and fortification composition comprising elemental sulphur; one or more of water insoluble zinc salts, complexes or derivatives thereof; elemental selenium or its salts, complexes, derivatives or mixture thereof; and at least one surfactant. The composition is in the form of granules or aqueous suspension. The crop nutrition and fortification composition is in the form of homogeneous mixture of elemental sulphur; one or more of water insoluble zinc salts, complex or derivative thereof; elemental selenium its salts, complexes, derivatives or mixture thereof; and at least one surfactant.

According to further embodiment, the said crop nutrition and fortification composition comprises fine particles in the size range of 0.1 micron to 30 microns and exhibits improved physical properties in terms of dispersibility, suspensibility, viscosity, spontaneity of dispersion, wettability and pourability or flowability. On account of superior physical characteristics, the composition of the present invention also finds a direct use in micro irrigation or drip irrigation systems.

The present composition has elemental sulphur content in the range of 1% to 90% by weight of the total composition, elemental zinc in the range of 0.1% to 50% by weight of the total composition and elemental selenium in the range of 0.001% to 10% by weight of the total composition.

The present invention particularly relates to a crop nutrition and fortification composition comprising:
i. elemental sulphur in the range of 1% to 90% by weight of the total composition;
ii. one or more of water insoluble zinc salts, complex or derivative thereof wherein the content of elemental zinc in the composition is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. at least one surfactant in the range of 0.1% to 40% by weight of the composition;
   wherein the composition comprises particles in the size range of 0.1 micron to 30 microns and wherein the composition is in the form of granules or aqueous suspension.

The inventor of the present invention has surprisingly found that the composition comprising elemental sulphur in the range of 1% to 90% by weight of the total composition; one or more of water insoluble zinc salts, complex or derivative thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition demonstrated synergistic effect compared to the activity of the individual active ingredient and combinations of two actives at a time.

In addition to the synergistic effect of the composition of the present invention in the form of water dispersible granules, water disintegrable granules or aqueous suspension provides excellent crop nutrition and fortification and improves yield, plant growth, vigor and nutritive value of the crop when the particles in the composition are in the size range of 0.1 micron to 30 microns.

The inventor of the present invention surprisingly found that when the composition comprises elemental sulphur, water insoluble zinc and selenium in the form of water dispersible granules, water disintegrable granules or aqueous suspension with the particles of the composition in the size range of 0.1 microns to 30 microns, it also enhances the stability of the formulation along with absorption of sulphur, zinc and selenium by the crops on application via soil or foliar route thereby resulting in strengthening and fortification of crops and thereby preventing pest and disease occurrence. The specific particle size range of the crop nutrient and fortification composition increases the surface area of elemental sulphur, zinc and selenium particles and thereby enables the product to cover wider surface area thus enabling the bio-effectiveness at substantially lower dosage. It was further surprisingly noted by the inventor that the present composition also addresses the unavailability of nutrients caused due to the long-term application of NPK fertilizers and thus made sulphur, zinc and selenium and other nutrients quickly available for uptake.

The inventor of the present invention surprisingly found that the composition of the present invention comprising elemental sulphur; one or more of water insoluble zinc salts, complex or derivative thereof; elemental selenium or its salts, complexes, derivatives or mixture thereof in specific concentrations not only demonstrated synergistic effect, but also provided nutrition to the plant, thus showing a significant enhancement in the yield as well as other crop characteristics such as plant height, root length and improved foliage, as compared to the individual application of nutrients. The present composition acts as a nutrient-use efficient composition while meeting the need of crops by providing a multi nutritive solution with improved uptake by crops in a single application.

According to an embodiment, elemental Sulphur is present in the range of 1% to 90% by weight of the total composition. According to an embodiment, elemental Sulphur is present in the range of 1% to 80% by weight of the total composition. According to an embodiment, elemental Sulphur is present in the range of 1% to 70% by weight of the total composition. According to an embodiment, elemental Sulphur is present preferably in the range of 1% to 65% by weight of the total composition. According to an embodiment, elemental Sulphur is preferably present in the range of 1% to 60% by weight of the total composition. According to an embodiment, elemental Sulphur is present in the range of 10% to 90% by weight of the total composition. According to an embodiment, elemental Sulphur is present in the range of 10% to 80% by weight of the total composition. According to an embodiment, elemental Sulphur is present in the range of 10% to 70% by weight of the total composition. According to an embodiment, elemental Sulphur is preferably present in the range of 10% to 60% by weight of the total composition. According to an embodiment, elemental Sulphur is preferably present in the range of 20% to 90% by weight of the total composition. According to an embodiment, elemental Sulphur is preferably present in the range of 20% to 80% by weight of the total composition. According to an embodiment, elemental Sulphur is preferably present in the range of 30% to 90% by weight of the total composition. According to an embodiment, elemental Sulphur is preferably present in the range of 30% to 80% by weight of the total composition. According to an embodiment, elemental Sulphur is preferably present in the range of 40% to 90% by weight of the total composition. According to an embodiment, elemental Sulphur is preferably present in the range of 40% to 80% by weight of the total composition.

According to an embodiment, zinc is present in the form of its water insoluble salts, derivatives or complexes thereof. According to a further embodiment, the elemental content of zinc in composition is in the range of 0.1% to 50% by weight of the total composition. According to an embodiment, elemental zinc is present in the range of 0.10% to 40% by weight of the total composition. According to an embodiment, elemental zinc is present in the range of 1% to 50% by weight of the total composition. According to an embodiment, elemental zinc is present in the range of 1% to 40% by weight of the total composition. According to an embodiment, elemental zinc is present preferably in the range of 5% to 50% by weight and more preferably present in the range of 5% to 40% by weight of the total composition. According to an embodiment, elemental zinc is present preferably in the range of 10% to 50% by weight and more preferably in the range of 10% to 40% by weight of the total composition.

According to an embodiment, water insoluble zinc salts, complexes or derivatives thereof is present in the range of 0.1% to 90% by weight of the total composition. According to an embodiment, water insoluble zinc salts, complexes or derivatives thereof is present in the range of 1% to 80% by weight of the total composition. According to an embodiment, water insoluble zinc salts, complexes or derivatives thereof is present in the range of 1% to 70% by weight of the total composition. According to an embodiment, water insoluble zinc salts, complexes or derivatives thereof is present in the range of 1% to 60% by weight of the total composition.

According to an embodiment, the water-insoluble Zinc salts include one or more of but not limited to Zinc Oxide, Zinc Carbonate, Zinc Sulphide, Zinc Molybdate, Zinc Phosphate, Zinc Borate, Zinc Silicate, Zinc Pyrophosphate, Zinc Citrate, complex or derivatives thereof. However, those skilled in the art will appreciate that it is possible to utilize other water insoluble Zinc salts, complexes or derivatives thereof without departing from the scope of the invention.

According to an embodiment, the water insoluble Zinc salt, complexes or derivatives thereof include one or more of Zinc containing minerals or ores or processed or refined ores or ores containing the trace nutrients selected from but not limited to Ashoverite, Sphalerite, Smithsonite, or Wurtzite. However, the above list of ores or minerals is exemplary and not meant to limit the scope of the invention.

According to an embodiment, selenium is present in its elemental form or in the form of its salts, derivatives or complexes thereof. According to an embodiment, the elemental selenium content in the composition is in the range of 0.001% to 10% by weight of the total composition. According to an embodiment, the elemental selenium content in the composition is in the range of 0.005% to 10% by weight of the total composition. According to an embodiment, the elemental selenium content in the composition is in the range of 0.01% to 10% by weight of the total composition. According to an embodiment, the elemental selenium content in the composition is in the range of 0.01% to 5% by weight of the total composition. According to an embodiment, the elemental selenium content in the composition is in the range of 0.1% to 10% by weight of the total composition. According to an embodiment, the elemental selenium content in the composition is in the range of 0.1% to 5% by weight of the total composition.

According to an embodiment, selenium in its salts, complexes, derivatives or mixture thereof is present in the range of 0.001% to 30% by weight of the total composition. According to an embodiment, selenium in its salts, complexes, derivatives or mixture thereof is present in the range of 0.001% to 20% by weight of the total composition. According to an embodiment, selenium in its salts, complexes, derivatives or mixture thereof is present in the range of 0.01% to 30% by weight of the total composition. According to an embodiment, selenium in its salts, complexes, derivatives or mixture thereof is present in the range of 0.01% to 20% by weight of the total composition.

According to a further embodiment, the derivatives or sources of selenium in the composition can include minerals. The trace nutrient can also be in the form of ore. The ores can include but are not limited to oxides; silicates, carbonate ores; sulphide ores; or halide ores.

According to a further embodiment, the salts of selenium include water soluble or water insoluble salts.

According to a further embodiment, the water-insoluble selenium salts include but are not limited to selenium, selenium carbonates, vanadium selenide, magnesium selenide, manganese selenide, selenium sulphide, copper selenide, iron selenide, molybdenum selenide, cobalt selenide, bismuth selenide, zinc selenide, copper selenite, calcium selenite, magnesium selenite, manganese selenite, or cobalt selenite. However, those skilled in the art will appreciate that it is possible to utilize other selenium water-insoluble salts without departing from the scope of the invention.

According to a further embodiment, the water-soluble selenium salts include but are not limited to selenium dioxide, selenourea, sodium selenide, potassium selenide, ammonium selenide, sodium selenite, potassium selenite, ammonium selenite, iron selenite, zinc selenite, sodium selenate, magnesium selenate, potassium selenate, calcium selenate, copper selenate, ammonium selenate, iron selenate, cobalt selenate or zinc selenate. However, those skilled in the art will appreciate that it is possible to utilize other selenium water-soluble salts without departing from the scope of the invention.

According to a further embodiment, selenium derivatives include but are not limited to potassium selenate, selenium sulfide, selenious acid, selenium oxychloride, selenic acid, selenium yeast etc. However, those skilled in the art will appreciate that it is possible to utilize other selenium derivatives without departing from the scope of the invention.

According to a further embodiment, selenium in the composition can also be in the form of minerals or processed or refined ores or ores containing the trace nutrients. The selenium ores include but are not limited to Ferroselite, Downeyite; Achávalite.

According to an embodiment, the crop nutrition composition may further comprise at least one additional plant nutrient. According to an embodiment, the additional plant nutrient is present in the range of from 0.001% to 80% by weight of the total composition.

According to an embodiment, the crop nutrition and fortification composition may further comprise one or more of iron salts, complex or derivative thereof; wherein the content of elemental iron is in the range of 0.10% to 60% by weight of the total composition.

According to an embodiment, the iron salts, complexes, derivatives thereof include water soluble and/or water insoluble iron salts; or complexes or derivatives or mixtures thereof. According to further embodiment, the water soluble iron salts can include one or more of but is not limited to iron sulphate, iron succinate, iron fumarate, iron humate, iron fulvate, iron citrate, iron ascorbate or mixtures thereof.

According to an embodiment, the iron salts, complexes, derivatives thereof particularly include water insoluble iron salts or complexes or derivatives or mixtures thereof. The inventor of the present invention found that when the crop nutrient and fortification composition further comprises iron in insoluble form, the composition not only enhanced the assimilation of these nutrients by plants but also demonstrated significant enhancement in the yield as well as other crop characteristics such as plant height, root length and improved foliage as compared to the individual application of these nutrients. The inventor also found that by virtue of the use of the insoluble forms of iron also addressed the problem of leaching of these nutrients when applied in soluble forms to the soil.

According to further embodiment, the water insoluble iron salts can include one or more of but is not limited to, iron oxide, iron hydroxide, iron phosphate, iron fumarate, iron succinate, iron sulphide, iron oxalate, iron sucrate, carbonyl iron, iron silicate, iron carbonate or mixtures thereof. The iron oxide can include, but is not limited to, Ferrous oxide (FeO), Ferric oxide (Fe₂O₃) or red oxide, and Ferroso ferric oxide (Fe₃O₄) or black iron oxide. Iron hydroxide includes, but is not limited to, Ferric hydroxide, yellow iron oxide (FeOOH), Iron hydroxide (Fe(OH)₃), Iron hydroxide (III), Iron oxyhydroxide and limonite. Iron phosphate can include, but is not limited to, Ferric phosphate, Ferric phosphate dehydrate, Ferric phosphate hydrate, Ferric glycerophosphate, Ferric phosphate, Ferrous pyrophosphate and Ferric pyrophosphate. Iron fumarate includes, but is not limited to Ferrous fumarate and Ferro fumarate. Iron succinate includes but is not limited to Ferrous succinate and Succinic acid Iron (II) salt. According to an embodiment, iron can be present in the crop nutrition and fortification composition in its elemental form or in the form of iron dust. However, those skilled in the art will appreciate that it is possible to utilize other water insoluble iron salts without departing from the scope of the invention.

According to further embodiment, the water insoluble iron can be in the form of minerals or processed or refined ores or ores containing the trace nutrients such as but not limited to Wustite, Magnetite, Hematite, Troilite, Goethite, Greigite, Siderite, Pyrite or Marcasite, or Bernalite. However, those skilled in the art will appreciate that it is possible to utilize other minerals of iron without departing from the scope of the invention.

According to an embodiment, the elemental iron content in the composition is in the range of 0.1% to 60% by weight of the total composition. According to an embodiment, the elemental iron content in the composition is in the range of 0.10% to 50% by weight of the total composition. According to an embodiment, the elemental iron content in the composition is in the range of 1% to 60% by weight of the total composition. According to an embodiment, the elemental iron content in the composition is in the range of 1% to 50% by weight of the total composition.

According to an embodiment, the crop nutrition and fortification composition comprises particles in the size range of 0.1 micron to 30 microns. According to an embodiment, the crop nutrition and fortification composition comprises particles in the size range of 0.1 micron to 25 microns. According to an embodiment, the crop nutrition and fortification composition comprises particles in the size range of 0.1 micron to 20 microns. According to an embodiment, the crop nutrition and fortification composition comprises particles in the size range of 0.1 micron to 15 microns. According to an embodiment, the crop nutrition and fortification composition comprises particles in the size range of 0.1 micron to 10 microns.

According to another embodiment, the crop nutrition composition of the present invention comprises particles having diameter distribution of D50 of about 20 microns. According to another embodiment, the crop nutrition composition of the present invention comprises particles having diameter distribution of D50 of about 15 microns. According to another embodiment, the crop nutrition composition of the present invention comprises particles having diameter distribution of D50 of about 10 microns. According to another embodiment, the crop nutrition composition of the present invention comprises particles having diameter distribution of D50 of about 5 microns.

According to another embodiment, the crop nutrition composition of the present invention comprises particles having diameter distribution of D90 of about 30 microns. According to another embodiment, the crop nutrition composition of the present invention comprises particles having diameter distribution of D90 of about 25 microns. According to another embodiment, the crop nutrition composition of the present invention comprises particles having diameter distribution of D90 of about 20 microns. According to another embodiment, the crop nutrition composition of the present invention comprises particles having diameter distribution of D90 of about 10 microns.

According to another embodiment, the crop nutrition composition of the present invention in the form of water dispersible granules or aqueous suspension comprises particles having diameter distribution of D50 of about 10 microns and D90 of 20 microns. According to another embodiment, the crop nutrition composition of the present invention in the form of water dispersible granules or aqueous suspension comprises particles having diameter distribution of D50 of about 5 microns and D90 of 10 microns.

The inventor of the present invention surprisingly observed that the present composition when formulated at a specific particle size of 0.1 micron to 30 microns, in particular 0.1 micron to 10 microns made the nutrients specifically sulphur, zinc and selenium readily available for uptake by the plants and increase the overall yield. Thus, the particle size range of 0.1 micron to 30 microns of the crop nutrition composition was found to be important not only in terms of ease of invention but also in terms of efficacy.

According to an embodiment, the crop nutrition and fortification composition in the form of granules has granules in the size range of 0.05 mm to 6 mm. According to a further embodiment, the granular crop nutrition and fortification composition when in the form of granules may have at least one dimension in a size range of 0.05 mm to 6 mm.

According to an embodiment, the crop nutrition and fortification composition in the form of water dispersible granules are in the size range of 0.05 mm to 4 mm.

According to an embodiment, the crop nutrition and fortification composition in the form of water dispersible granules are in the size range of 0.05 mm to 3 mm. According to an embodiment, the crop nutrition and fortification composition in the form of water dispersible granules are preferably in the size range of 0.05 mm to 2.5 mm. According to an embodiment, the crop nutrition and fortification composition in the form of water dispersible granules are preferably in the size range of 0.05 mm to 2 mm.

According to a further embodiment, the crop nutrition and fortification composition in the form of water dispersible granules may have at least one dimension in a size range of 0.05 mm to 3 mm. According to a further embodiment, the crop nutrition and fortification composition in the form of water dispersible granules may have at least one dimension in a size range of 0.05 mm to 2 mm.

According to an embodiment, the crop nutrition and fortification composition in the form of water disintegrable granular form has granules in the size range of 0.1 mm to 6 mm. According to a further embodiment, the crop nutrition and fortification composition in the form of water disintegrable granules may have at least one dimension in a size range of 0.1 mm to 6 mm.

According to an embodiment, the crop nutrition composition is devoid of fertilizers that primarily comprise ammonium sulfate or urea or nitrogen fertilizers or other conventional fertilizers.

According to an embodiment, the present invention relates to a crop nutrition composition in the form of water dispersible granules, water disintegrable granules or aqueous suspension comprising of
i. elemental sulphur in the range of 1% w/w to 90% w/w of the total composition;
ii. one or more of water insoluble zinc salts, complex or derivative thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. and at least one surfactant in the range of 0.1% to 40% by weight of the total composition;
   wherein the composition comprises particles in the size range of 0.1 micron to 30 microns.

According to an embodiment, the present invention relates to a crop nutrition composition in the form of water dispersible granules comprising of
i. elemental sulphur in the range of 20% w/w to 90% w/w of the total composition;
ii. one or more of water insoluble zinc salts, complex or derivative thereof wherein the elemental zinc content is in the range of 0.10% to 50% by weight of the total composition;
iii. elemental selenium or its salts, complexes, derivatives or mixture thereof wherein the elemental selenium content is in the range of 0.001% to 10% by weight of the total composition; and
iv. and at least one surfactant in the range of 0.1% to 40% by weight of the total composition;
   wherein the composition comprises particles in the size range of 0.1 micron to 30 microns.

According to an embodiment, the crop nutrition and fortification composition further comprises at least one agrochemically acceptable excipient. According to a further embodiment, the agrochemically acceptable excipient is present in the range of from 0.1% w/w to 98% w/w of the total composition. According to a further embodiment, the agrochemically acceptable excipient is present in the range of from 0.10% w/w to 95% w/w of the total composition.

According to an embodiment, the crop nutrition and fortification composition comprises one or more of agrochemically acceptable excipient selected from one or more of surfactants, disintegrating agents, fillers or carriers or diluents, spreading agents, colorants, anticaking agents, binders, buffers or pH adjusters or neutralizing agents, pigments, stabilizers, antifoaming agents or defoamers, penetrants, structuring agents, humectants, sticking agents, anti-freezing agent or freeze point depressants, chelating or complexing or sequestering agents preservatives. However, those skilled in the art will appreciate that it is possible to utilize additional agrochemically acceptable excipients without departing from the scope of the present invention. The agrochemically acceptable excipients are commercially manufactured and available through various companies.

According to an embodiment, the surfactants that are used in the crop nutrition and fortification composition of the present invention include one or more of emulsifiers, wetting agents, and dispersing agents. According to an embodiment, the surfactants that are used in the composition include one or more of anionic, non-ionic, and polymeric surfactants.

The anionic surfactants include one or more of, but not limited to a salt of Fatty Acid, a Polycarboxylate, Alkyl Ether Sulfates, an Alkyl Sulfate, an Alkylarylsulfate, an Alkylaryl Sulfonate, an Aryl Sulfonate, a Lignin Sulfonate, an Alkyl Diphenyl Ether Disulfonate, a Polystyrene Sulfonate, a Salt of Alkylphosphoric Acid Ester, an Alkylaryl Phosphate, a Styrylaryl Phosphate, a Salt Of Polyoxyethylene Alkyl Ether Sulfuric Acid Ester, Alpha Olefin Sulfonate Sodium Salt, Alkyl Benzene Sulfonate or Its Salts, Sodium Lauroyl sarcosinate, Sulfosuccinates, Polyacrylates, Alkyl Ether Phosphate, a Salt of Polyoxyethylene alkylaryl Phosphoric Acid Ester, Sulfosuccinates—Mono and other Diesters, Phosphate Esters, Alkyl Naphthalene Sulfonate-Isopropyl and Butyl Derivatives; Alkyl Aryl Ether Phosphates, a salt of Polyoxyethylene Aryl Ether Phosphoric Acid Ester, Mono-Alkyl Sulphosuccinates, Aromatic Hydrocarbon Sulphonates, Ammonium Laurylsulphate, Soap, Soap Substitute, Sodium Alkyl Sulfate, Sodium Dodecyl Sulfate, Sodium Dodecyl benzenesulfonate, Sodium Laurate, Sodium Laurethsulfate, Sodium Nonanoyloxybenzenesulfonate, Alkyl Carboxylates, Sodium Stearate, Alpha Olefin Sulphonates, Naphthalene Sulfonate Salts, Alkyl Naphthalene Sulfonate Fatty Acid salts, Naphthalene Sulfonate Condensates-Sodium salt, Fatty Alcohol Sulphates, Alkyl Naphthalene Sulfonate Condensates-Sodium Salt, ANaphthalene Sulfonic Acid Condensed with Formaldehyde or a Salt of Alkyl naphthalene Sulfonic Acid condensed with Formaldehyde or salts or derivatives thereof. However, those skilled in the art will appreciate that it is possible to utilize different anionic surfactants without departing from the scope of the present invention.

The non-ionic surfactants or polymeric surfactants include one or more of but not limited to Polyol Esters, Polyol Fatty Acid Esters, Ethoxylated and Propoxylated Fatty Alcohols, EO and PO Block Copolymers, Di, Tri-Block Copolymers, Polysorbates, Alkyl Polysaccharides, Polyoxyethylene Glycol, Sorbitan Derivatives, Fatty Acid Esters of Sorbitan (Spans) and Their Ethoxylated Derivatives (Tweens), Cocamide Monoethanolamine (MEA), Decyl, Narrow-Range Ethoxylate, Oleyl Alcohol, PEG-10, Polysorbate, Polysorbate 20, Polysorbate 80, Sorbitan, Sorbitanmonolaurate, Sorbitanmonostearate, Sorbitantristearate, Stearyl Alcohol, Castor Oil Ethoxylate, Polyglycol Ethers, Polyadducts of Ethylene Oxide and Propylene Oxide, Polyoxy Ethylene Sorbitan, Fatty Acid Polyglyceride, Polyoxyethylene Alkyl Ether, Polyoxyethylenealkylaryl Ether, a Polyoxyethylenestyrylaryl Ether, a Polyoxyethylene Glycol Alkyl Ether, Alcohol Ethoxylates—C6 to C16/18 Alcohols, Linear and Branched, Alcohol Alkoxylates—Various Hydrophobes and EO/PO Contents and Ratios, a Polyoxyethylene Hydrogenated Castor Oil, salts or derivatives thereof. However, those skilled in the art will appreciate that it is possible to utilize different non-ionic surfactants or polymeric surfactants without departing from the scope of the present invention.

According to an embodiment, the surfactant is present in an amount of 0.10% to 40% by weight of the total composition. According to an embodiment, the surfactant is present in an amount of 0.1% to 30% by weight of the total composition. According to an embodiment, the surfactant is present in an amount of 0.1% to 20% by weight of the total composition.

According to an embodiment, the dispersing agents which are used in the crop nutrition composition include, but not limited to non-ionic dispersants selected from one or more of polyvinyl pyrrolidone, polyvinyl alcohol, polyoxyethylene alkyl ethers, polyoxyethylene alkyl phenyl ether, ethoxylated fatty acids, aliphatic alcohol ethoxylates; alkyl ethoxylates; EO-PO block and graft copolymers; However, those skilled in the art will appreciate that it is possible to utilize different non-ionic dispersants without departing from the scope of the present invention.

According to an embodiment, the dispersing agents which are used in the crop nutrition and fortification composition include, but not limited to anionic dispersants selected from one or more of tristyrylphenolethoxylate phosphate esters; lignin sulphonates, phenyl naphthalene sulphonates, alkali metal, alkylarylsulfonates, alkylsulfonates, mixture of sodium salt of naphthalene sulphonic acid urea formaldehyde condensate and sodium salt of phenol sulphonic formaldehyde condensate, polycarboxylates, sodium alkyl benzene sulfonates, sodium salts of sulfonated naphthalene, sodium naphthalene sulfonate formaldehyde condensates, condensation products of aryl sulphonic acids and formaldehyde, polyaromatic sulfonates, sodium alkyl aryl sulfonates and kraft lignin. However, those skilled in the art will appreciate that it is possible to utilize different anionic dispersants without departing from the scope of the present invention.

According to an embodiment, the dispersing agent is present in an amount of 0.1% to 40% by weight of the total composition. According to an embodiment, the dispersing agent is present in an amount of 0.1% to 30% by weight of the total composition. According to an embodiment, the dispersing agent is present in an amount of 0.1% to 20% by weight of the total composition.

According to an embodiment the wetting agents used in the crop nutrition composition include, but are not limited to one or more of phenol naphthalene sulphonates, alkyl naphthalene sulfonate, sodium alkyl naphthalene sulfonate, naphthalene sulphonate sodium salt, dibutylnaphthalene-sulfonic acid, alkylarylsulfonates, dioctyl sulfosuccinate, polyoxyethoxylated fatty alcohols, alkane sulfonates, alkylbenzene sulfonates, alkyl ether phosphates, alkyl ether sulphates and alkyl sulfosuccinic monoesters, salts, derivatives thereof. However, those skilled in the art will appreciate that it is possible to utilize different wetting agents without departing from the scope of the present invention.

According to an embodiment, the wetting agent is present in an amount of 0.10% to 30% by weight of the total composition. According to an embodiment, the wetting agent is present in an amount of 0.1% to 20% by weight of the total composition. According to an embodiment, the wetting agent is present in an amount of 0.1% to 10% by weight of the total composition.

According to an embodiment, the carriers that are used in the crop nutrition and fortification composition of the present invention include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention.

The solid carriers include natural minerals like clay such as china clay, acid clay, kaolin such as kaolinite, dickite, nacrite, and synthetic and diatomaceous silicas, micas, such as pyrophyllite, talc, silicas such as cristobalite and quartz, such as attapulgite and sepiolite, vermiculite, laponite, pumice, bauxite, hydrated aluminas, perlite, sodium bicarbonate, limestone, natural and synthetic silicates, silicas,surface-modified silicas, zeolite, diatomaceous earth, loess, mirabilite, white carbon, slaked lime, synthetic silicic acid, starch, modified starch, cellulose, plant carriers such as cellulose, chaff, wheat flour, wood flour, starch, rice bran, wheat bran, and soybean flour, casein sodium, sucrose, salt cake, potassium pyrophosphate, sodium tripolyphosphate or derivatives or mixtures thereof. Commercially available Silicates are Aerosil brands, Sipemat brands as Sipemat® 22S and CALFLO E, and kaolin 1777.

According to an embodiment, the carrier is present in an amount of 0.1% to 95% by weight of the composition. According to a further embodiment, the carrier is present in an amount of 0.1% to 80% by weight of the composition. According to a further embodiment, the carrier is present in an amount of 0.1% to 70% by weight of the composition. According to a further embodiment, the carrier is present in an amount of 0.1% to 50% by weight of the composition.

According to an embodiment, the antifoaming agents or defoamers which are used in the crop nutrition and fortification composition of the present invention include but are not limited to one or more of silica, siloxane, silicone dioxide, polydimethyl siloxane, alkyl polyacrylates, ethylene oxide/propylene oxide copolymers, silicone oils and magnesium stearate or derivatives thereof. Preferred antifoaming agents include silicone emulsions (such as, e.g., Silikon® SRE, Wacker or Rhodorsil® from Rhodia), long-chain alcohols, fatty acids, fluoro-organic compounds. However, those skilled in the art will appreciate that it is possible to utilize different antifoaming agents without departing from the scope of the present invention.

According to an embodiment, the anti-foaming agent is present in an amount of 0.01% to 20% by weight of the total composition. According to an embodiment, the anti-foaming agent is present in an amount of 0.01% to 10% by weight of the total composition.

According to an embodiment, the pH-adjusters or buffers or neutralizing agents that are used in the composition include both acids and bases of the organic or inorganic type and mixtures thereof. According to a further embodiment, pH-adjusters or buffers or neutralizing agents include, but are not limited to one or more of organic acids, inorganic acids, and alkali metal compounds or salts, derivatives thereof. According to an embodiment, the organic acids include, but not limited to one or more of citric, malic, adipic, fumaric, maleic, succinic, and tartaric acids, or salts, derivatives thereof, and the mono-, di-, or tribasic salts of these acids or derivatives thereof. According to an embodiment, the salts of inorganic acids include, but not limited to one or more of alkali metal salts such as, sodium chloride, sodium nitrate, potassium nitrate, sodium sulfate, potassium sulfate, sodium monohydrogen phosphate, potassium monohydrogen phosphate, sodium dihydrogen phosphate, potassium dihydrogen phosphate and the like. Mixtures can also be used to create a pH-adjusters or buffers or neutralizing agents. However, those skilled in the art will appreciate that it is possible to utilize different pH adjusters without departing from the scope of the present invention.

According to an embodiment, the pH adjusters or buffers are present in an amount of 0.01% to 20% by weight of the total composition.

According to an embodiment, the anticaking agents which are used in the crop nutrition composition include, but are not limited to one or more of polysaccharides, fumed and precipitated silica (white carbon), a petroleum resin, Foammaster® Soap L sodium stearate, Brij® 700 polyoxyethylene (100) stearylether, sodium acetate, sodium metasilicate, sodium alkylsulfosuccinates, or derivatives thereof. However, those skilled in the art will appreciate that it is possible to utilize different anticaking agents without departing from the scope of the present invention.

According to an embodiment, the anticaking agent is present in an amount of 0.1% to 20% by weight of the total composition.

According to an embodiment, the spreading agents which are used in the composition include but are not limited to one or more of copolymer of maleic acid with a styrene compound, a (meth)acrylic acid copolymer, aliphatic alcohols, vegetable oils such as cottonseed or inorganic oils, petroleum distillates, trisiloxanes and modified trisiloxanes, or derivatives thereof. However, those skilled in the art will appreciate that it is possible to utilize different spreading agents without departing from the scope of the present invention.

According to an embodiment, the spreading agent is present in an amount of 0.01% to 20% w/w of the total composition.

According to an embodiment, the sticking agents which are used in the composition include, but not limited to one or more of paraffin, a polyamide resin, polyacrylate, polyoxyethylene, wax, latex, polyvinyl pyrrolidone, gums such as xanthan gum, vegetable oils such as cottonseed, or inorganic oils, petroleum distillates, modified trisiloxanes, polyglycol, a synthetic resin emulsion or salts or derivatives thereof. However, those skilled in the art will appreciate that it is possible to utilize different sticking agents without departing from the scope of the present invention.

According to an embodiment, the sticking agent is present in an amount of 0.01% to 30% w/w of the total composition.

According to an embodiment, the structuring agents that are used in the crop nutrition composition include, but are not limited to one or more of thickeners, viscosity modifiers, tackifiers, suspension aids, rheological modifiers or anti-settling agents. A structuring agent prevents sedimentation of the active ingredient particles after prolonged storage.

According to an embodiment, the structuring agents which are used in the composition include, but not limited to one or more of polyacrylics, polysaccharides, cellulose derivatives, co-polymers of cellulose derivatives, polyvinyl alcohol and derivatives; clays such as kaolin, smectite, attapulgites and gums such as guar gum, xanthan gum, gelatin, dextrin, fumed silica, mixture of fumed silica and fumed aluminium oxide, swellable polymers, poly(ethylene glycol), stachyose, celluloses such as hemicellulose, carboxymethylcellulose, ethylcellulose, hydroxyethylcellulose, hydroxy-methyl ethyl cellulose, hydroxyl ethyl propyl cellulose, methyl hydroxyethyl cellulose, methylcellulose; plant starches such as corn starch and potato starch. However, those skilled in the art will appreciate that it is possible to utilize different structuring agents without departing from the scope of the present invention.

Preferred structuring agents include one or more of xanthan gum, aluminum silicate, Hydroxypropyl methylcellulose, carboxymethyl cellulose, methylcellulose, polysaccharide, alkaline earth metal silicate, clays, gelatin, and polyvinyl alcohol.

According to an embodiment, the structuring agent is present in an amount of 0.01% to 20% by weight of the composition. According to an embodiment, the structuring agent is present in an amount of 0.01% to 10% by weight of the composition. According to an embodiment, the structuring agent is present in 0.01% to 5% by weight of the composition.

According to an embodiment, the anti-freezing agents or freezing point depressants used in the composition include, but are not limited to one or more of polyhydric alcohols such as ethylene glycol, diethylene glycol, dipropylene glycol, propylene glycol, glycerol, monohydric or polyhydric alcohols, glycol ethers, glycerol, However, those skilled in the art will appreciate that it is possible to utilize different anti-freezing agents without departing from the scope of the present invention.

According to an embodiment, the anti-freezing agents or freezing point depressants is present in an amount of 0.01% to 30% by weight of the total composition.

According to an embodiment, the chelating or complexing or sequestering agents which are used in the composition include, but not limited to one or more of polycarboxylic acids such as polyacrylic acid and the various hydrolyzed poly(methyl vinyl ether/maleic anhydride); N-hydroxyethyliminodiacetic acid, nitrilotriacetic acid (NTA), N,N,N′,N′-ethylenediaminetetraacetic acid, N-hydroxyethyl-N, N′,N′-ethylenediaminetriacetic acid and N,N,N′,N″,N″-diethylenetriaminepentaacetic acid; α-hydroxy acids, such as citric acid, tartaric acid and gluconic acid; orthophosphates, disodium phosphate, monosodium phosphate; condensed phosphates, such as sodium tripolyphosphate, tetrasodium pyrophosphate, sodium hexametaphosphate and sodium tetrapolyphosphate; ethylene diamine tetraacetic acid (EDTA), diethylene triamine pentaacetic acid (DTPA), N-hydroxyethyl-ethylenediamine-triacetic acid (HEDTA), ethylenediamine diacetate (EDDA), ethylene diamine di(o-hydroxyphenylacetic) acid (EDDHA), cyclohexane diamine tetraacetic acid (CDTA), fulvic acid, ulmic acid, nucleic acids, cyclodextrin, humic acid, pyrophosphate. However, those skilled in the art will appreciate that it is possible to utilize different chelating agents without departing from the scope of the present invention.

According to an embodiment, the chelating agents is present in an amount of 0.01% to 30% by weight of the total composition.

According to an embodiment, the penetrant which is used in the composition include, but not limited to one or more of alcohol, glycol, glycol ether, ester, amine, alkanolamine, amine oxide, quaternary ammonium compound, triglyceride, fatty acid ester, fatty acid ether, N-methyl pyrrolidone, dimethyl formamide, dimethyl acetamide, or dimethyl sulfoxide, polyoxyethylenetrimethylolpropanemonooleate, polyoxyethylene sorbitan monooleate polyoxyethylenetrimethylolpropanedioleate, polyoxyethylene trimethylol propane trioleate, polyoxyethylene sorbitol hexaoleate. However, those skilled in the art will appreciate that it is possible to utilize different penetrants without departing from the scope of the present invention.

According to an embodiment, the penetrant is present in an amount of 0.01% to 30% by weight of the total composition.

According to an embodiment, the humectant is selected from, but not limited to one or more of polyoxyethylene/polyoxypropylene copolymers, particularly block copolymers. Other humectants are propylene glycol, monoethylene glycol, hexylene glycol, butylene glycol, ethylene glycol, diethylene glycol, poly (ethylene glycol), poly (propylene glycol), glycerol and the like; polyhydric alcohol compounds such as propylene glycol ether, derivatives thereof. However, those skilled in the art will appreciate that it is possible to utilize different humectants without departing from the scope of the present invention.

According to an embodiment, the humectant is present in the range of 0.10% to 40% by weight of the total composition.

According to an embodiment, the stabilizers which are used in the agricultural composition include, but not limited to one or more of peroxide compounds such as hydrogen peroxide and organic peroxides, zeolite, antioxidants such as phenol compounds, phosphoric acid compounds, EDTA, sodium sulphites, citric acid, citrates and the like. However, those skilled in the art will appreciate that it is possible to utilize other conventionally known stabilizers without departing from the scope of the present invention.

According to an embodiment, the stabilizer is present in the range of 1% to 30% by weight of the total composition.

According to an embodiment, preservative is selected from one or more of formic acid, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3(2H)-one, BIT, commercially available as Proxel® types from Arch Biocides Ltd.) or 2-methyl-4,5-trimethylene-2H-isothiazol-3-one (MTIT), Proxel® from Arch Biocides Ltd. or Acticide® RS from Thor Chemie and Kathon® MK from Lanxess, Sodium Propinoate, Sodium Benzoate, Propyl Paraben, Propyl Paraben Sodum, Potassium Sorbate, Potassium Benzoate, Phenyl Mercuric Nitrate, Phenyl Etehyl Alcohol, Sodium, Ethylparaben, Methylparaben, Butylparaben, Bezyl Alcohol, Benzothonium Chloride, Cetyl pyridinium Chloride, Antioxidants includes but not limited to one or more of imidazole and imidazole derivatives (e.g. urocanic acid), 4,4′-thiobis-6-t-butyl-3-methylphenol, 2,6-di-t-butyl-p-cresol (BHT), penta erythrityl tetrakis[3-(3,5,-di-t-butyl-4-hydroxyphenyl)]propionate; amine antioxidants. However, those skilled in the art will appreciate that it is possible to utilize other conventionally known preservatives without departing from the scope of the present invention.

According to an embodiment, the preservative is present in the range of 0.01% to 2% by weight of the total composition.

According to an embodiment, the pigments and colorants are selected from but not limited to synthetic chemicals obtained from various manufacturers. The pigments and colorants can be water soluble or water insoluble, in the form of lakes. Dyes can be solvent dyes, acid dyes or basic dyes. Examples of such products include, but not limited, Unisperse Red 3855, Pigmosol Agro Red 3785, pigment 15. However, those skilled in the art will appreciate that it is possible to utilize other conventionally known pigments and colorants without departing from the scope of the present invention.

According to an embodiment, the pigments and colorants are present in the range of 0.01% to 5% by weight of the total composition.

According to an embodiment, the disintegrating agents which are used in the agricultural composition include, but not limited to one or more of inorganic water soluble salts e.g. sodium chloride; water soluble organic compounds such as agar, hydroxypropyl starch, carboxymethyl starch ether, tragacanth, cross-linked sodium carboxymethyl cellulose, sodium tripolyphosphate, sodium hexametaphosphate, metal stearates, a cellulose powder, dextrin, methacrylate copolymer, Polyplasdone® XL-10 (crosslinked polyvinyl pyrrolidone), poly(vinylpyrrolidone). However, those skilled in the art will appreciate that it is possible to utilize other conventionally known disintegrating agents without departing from the scope of the present invention.

According to an embodiment, the disintegrating agent is present in the range of 0.5% to 15% by weight of the total composition.

According to an embodiment, the binding agents or binders that are used in the agricultural composition include, but not limited to one or more of maltodextrin, carbohydrates such as monosaccharides, disaccharides, oligosaccharides and polysaccharides, complex organic substance, synthetic organic polymers or derivatives and combinations thereof. However, those skilled in the art will appreciate that it is possible to utilize other conventionally known binding agents without departing from the scope of the present invention.

According to an embodiment, the binder is present in the range of 0.1% to 10% by weight of the total composition.

It has been surprisingly found that the crop nutrition and fortification composition of the present invention has enhanced and improved physical properties of dispersibility, suspensibility, wettability, viscosity, pourability, flowability and spontaneity of dispersion providing ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined.

According to an embodiment, the composition of the present invention has a wettability of less than 2 minutes. According to an embodiment, the composition has a wettability of less than 1 minute.

Dispersibility of the water dispersible granular composition of the present invention is determined as per the standard CIPAC test, MT 174. According to an embodiment, the water dispersible granular composition has a dispersibility of at least 30%. According to an embodiment, the water dispersible granular composition has can dispersibility of at least 50%. According to an embodiment, the water dispersible granular composition has a dispersibility of at least 70%. According to an embodiment, the water dispersible granular composition has a dispersibility of at least 90%. The composition of the present invention disperses uniformly into finer particles in the size range of 0.1 micron to 30 microns when comes in contact with water.

According to an embodiment, the crop nutrition composition in the form of water dispersible granules exhibit almost instantaneous dispersion thus making the actives readily available to the crops.

According to an embodiment, the composition demonstrates a dispersibility of more than 85% under ATS. According to an embodiment, the composition demonstrates a dispersibility of more than 70% under ATS. According to an embodiment, the composition demonstrates a dispersibility of more than 50% under ATS. According to an embodiment, the composition demonstrates a dispersibility of more than 40% under ATS.

Attrition resistance determines the resistance of a granular material to wear. The granular composition of the present has good attrition resistance. The Samples can be tested for attrition as per the CIPAC Handbook specified test, “MT 178.2—Attrition resistance of granules”. According to an embodiment, the attrition resistance of the granular composition of the present invention is at least 50%. According to an embodiment, the attrition resistance of the granular composition of the present invention is at least 80%. According to an embodiment, the attrition resistance of the granular composition of the present invention is at least 90%.

According to an embodiment, the composition of the present invention in the form of water dispersible granules or aqueous suspension passes the wet sieve retention test. The test is used to determine the amount of non-dispersible material in formulations that are applied as dispersions in water. The wet sieve retention value of the agrochemical composition in the form of liquid suspension and granules is measured by using the Standard CIPAC Test MT-185 which describes a procedure for measuring the amount of material retained on the sieve. A sample of the formulation is dispersed in water and the suspension formed is transferred to a sieve and washed. The amount of the material retained on the sieve is determined by drying and weighing

According to an embodiment, the composition of the present invention in the form of water dispersible granule or aqueous suspension has a wet sieve retention value on a 75-micron sieve of less than 2%. According to an embodiment, the composition has a wet sieve retention value on a 75-micron sieve of less than 0.2%. The wet sieve retention value of less than 2% indicates that the composition helps in the easy invention of the formulation preventing clogging of the nozzles or filter equipment.

Suspensibility is defined as the amount of active ingredient suspended after a given time in a column of liquid of stated height, expressed as a percentage of the amount of active ingredient in the original suspension. The test for suspensibility is done as per the CIPAC Handbook, “MT 184 Test for Suspensibility”.

According to an embodiment, the composition of the present invention has a suspensibility of at least 30%. According to an embodiment, the composition has a suspensibility of at least 60%. According to an embodiment, the composition has a suspensibility of at least 80%. According to an embodiment, the composition has a suspensibility of at least 90%.

According to an embodiment, the composition of the present invention demonstrates superior suspensibility under accelerated storage condition (ATS). According to an embodiment, the composition demonstrates a suspensibility of more than 85% under ATS. According to an embodiment, the composition demonstrates a suspensibility of more than 60% under ATS. According to an embodiment, the composition demonstrates a suspensibility of more than 40% under ATS.

According to an embodiment, the crop nutrition composition in the form of aqueous suspension is not highly concentrated and is easily pourable. The viscosity of a fluid is a measure of its resistance to gradual deformation by shear stress or tensile stress.

According to an embodiment, viscosity of the aqueous suspension is determined as per CIPAC MT-192. A sample is transferred to a standard measuring system. The measurement is carried out under different shear conditions and the apparent viscosities are determined. During the test, the temperature of the liquid is kept constant. According to an embodiment, the liquid suspension composition has a viscosity at 25° C. of 200 cps to 2000 cps which makes it pourable. According to an embodiment, the liquid suspension composition has a viscosity at 25° C. of 200 cps to 1000 cps.

According to an embodiment, the aqueous suspension composition has a viscosity at 25° C. of less than 2000 cps. According to an embodiment, the liquid suspension composition has a viscosity at 25° C. of less than 1000 cps. Too viscous and highly concentrated composition tends to form a cake making it unpourable and thus is undesirable.

According to an embodiment, the liquid suspension composition of the invention is easily pourable. The pourability is the measure of the percent of residue.

According to an embodiment, the pourability of the composition is determined as per CIPAC MT-148.1 by allowing the composition to stand for 24 hours and the amount remaining in the container after a standardized pouring procedure is determined. The container is rinsed and the amount remaining is determined and the maximum rinsed residue in percent is calculated. According to a further embodiment, the pourability of composition is less than 5% rinsed residue. According to a further embodiment, the pourability of the composition is preferably less than 2.5% rinsed residue.

According to an embodiment, the spontaneity of dispersion is measured as per CIPAC MT 160. It involves preparing 250 ml of a mixture of formulation and water, mixed with only one inversion of the measuring cylinder. After standing under defined conditions the top nine-tenths is removed, and the remaining tenth assayed chemically, gravimetrically or by solvent extraction. The spontaneity of dispersion is readily calculated. According to an embodiment, the suspension concentrate composition has a spontaneity of dispersion of 30%. According to an embodiment, the composition has a spontaneity of dispersion of 60%. According to an embodiment, the composition has a spontaneity of dispersion of 80%. According to an embodiment, the composition has a spontaneity of dispersion of 95%.

According to an embodiment, the composition of the present invention demonstrates superior stability towards heat, light, temperature and caking. According to an embodiment, the stability exhibited by the composition is at least 3 years. According to a further embodiment, the stability exhibited by the composition is at least 2 years. According to a further embodiment, the stability exhibited by the composition is at least 1 year. According to a further embodiment, the stability exhibited by the composition is at least 6 months.

According to an embodiment, the crop nutrition and fortification composition in the form of water dispersible granules has hardness of less than 4 Newtons. According to further embodiment, the crop nutrition composition in the form of water dispersible granules hardness of less than 3 Newtons. According to further embodiment, the crop nutrition composition in the form of water dispersible granules has hardness of less than 2 Newtons. According to further embodiment, the crop nutrition composition in the form of water dispersible granules preferably has hardness of less than 1 Newtons.

More preferably, the crop nutrition composition in the form of water dispersible granules has a nil hardness. The reference to nil hardness is indicative of the fact that the hardness of the granules cannot be measured by the hardness measuring apparatus. The hardness exhibited by the granules can be estimated by hardness testers such as the ones provided by Vinsyst Portable Table Hardness Tester VTHT series.

According to an embodiment, the present invention relates to a process for preparing crop nutrition and fortification composition of the present invention comprising elemental sulphur in the range of 1% to 90% by weight of the total composition; one or more of water insoluble zinc salts, complexes or derivatives thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition and at least one surfactant in the range of 0.10% to 40% by weight of the total composition; wherein the composition has particles in the size range of 0.1 to 30 microns and wherein the composition is in the form of water dispersible granules, water disintegrable granules or aqueous suspension.

According to further embodiment, the crop nutrition and fortification composition in the form of water dispersible granules is made by various techniques such as spray drying, fluidized bed granulation, extrusion, freeze drying, spheronization etc.

The invention also relates to a process for preparing the crop nutrition and fortification composition in the form of water dispersible granules, the process comprising:
a) milling a mixture of:
   i) elemental sulphur in the range of 1% to 90% by weight of the total composition;
   ii) one or more of water insoluble zinc salts, complexes or derivatives thereof wherein the content of elemental zinc in the composition is in the range of 0.1% to 50% by weight of the total composition;
   iii) elemental selenium or its salts, complexes, derivatives or mixture thereof wherein the elemental selenium content is in the range of 0.001% to 10% by weight of the total composition; and
   iv) at least one surfactant in the range of 0.10% to 40% by weight of the total composition
in water to obtain a slurry or wet mix, wherein the particles are in the size range of 0.1 to 30 microns and
b) drying the slurry or wet mix in a spray dryer, fluid bed dryer, or any suitable granulating equipment to obtain water dispersible granules.

The water dispersible granules are further sieved to remove the undersized and oversized granules and obtain the desired size.

According to another embodiment, the crop nutrition composition in the form of water dispersible granules is also made by dry milling a mixture of.
i) elemental sulphur;
ii) one or more of water insoluble zinc salts, complex or derivative thereof;
iii) elemental selenium or its salts, complexes, derivatives mixture thereof; and
iv) at least one surfactant
   in an air mill or a jet mill to obtain a homogeneous mixture with fine particle size.

Water is added to the dry powder and the mixture is blended to obtain a dough or paste or wet mix, which is then extruded through an extruder to obtain the granules comprising particles in the size range of 0.1 micron-30 microns. The water dispersible granules are further sieved to remove the undersized and oversized granules and obtain the desired size.

According to an embodiment, the process of preparing the aqueous suspension composition involves the homogenization of mixture of elemental sulphur; one or more of water insoluble zinc salts, complex or derivative thereof; elemental selenium or its salts, complexes, derivatives or mixture thereof; and at least one surfactant to obtain a suspension; and wet milling the obtained suspension to provide composition with a particle size range of 0.1 to 30 microns.

The process of preparing the aqueous suspension, involves homogenization of one or more of excipients by feeding them into a vessel provided with stirring facilities. Elemental sulphur and one or more of water insoluble zinc salts, complex or derivative thereof; elemental selenium or its salts, complexes, derivatives or mixture thereof are added to the homogenized blend and stirred continuously for about 5 to 10 min. until the total mixture becomes homogeneous. Subsequently, the suspension obtained is passed through the wet mill to obtain a desired particle size in the range of 0.1 to 30 microns. If required, one or more of excipients such as structuring agent or optionally biocide or preservatives are added to the obtained suspension, under continuous homogenization. However, those skilled in the art will appreciate that it is possible to modify or alter or change the process or process parameters to obtain suspension concentrate composition without departing from the scope of the present invention.

According to an embodiment, the composition of the present invention is at least one of a crop nutrition composition, crop protection composition, a crop strengthener composition, a yield enhancer composition.

According to an embodiment, the invention also relates to a method of enhancing the nutrient uptake by the plant and improving plant health and yield by treating a plant, plant propagation material, locus or parts thereof, a seed, seedling or surrounding soil with the crop nutrition and fortification composition in the form of water dispersible granules, water disintegrable granules or aqueous suspension comprising elemental sulphur in the range of 1% to 90% by weight of the total composition; one or more of water insoluble zinc salts, complex or derivative thereof wherein the content of elemental zinc in the composition is in the range of 0.1% to 50% by weight of the total composition; elemental selenium or its salts, complexes, derivatives or mixture thereof wherein the elemental selenium content is in the range of 0.001% to 10% by weight of the total composition; and at least one surfactant in the range of 0.10% to 40% by weight of the total composition, wherein the composition has particles in the size range of 0.1 to 30 microns. The composition may be sprayed directly to the plant, such as its foliage or applied to the plant propagation material, before it is sown or planted, or to the locus thereof. The present invention further relates to a method of treating plants and meeting their nutritional requirement by making essential nutrients like sulphur, zinc and selenium available to them and also unlocking other micronutrients and trace elements present in the soil which hitherto were not available because of various factors primarily being soil degradation on account of excessive use of synthetic fertilizers.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, broad casting etc. The composition is also applied in the form of a foliar spray.

The rates of application or the dosage of the composition depends on the type of use, the type of crops, or the specific active ingredients in the composition but is such that the crop nutrition active ingredient, is in an effective amount to provide the desired action (such as crop nutrition, crop yield).

According to an embodiment the composition is applied at least 1 to 5 times in a life cycle of the crops.

It was observed that the composition of the present invention comprising elemental sulphur; one or more of water insoluble zinc salts, complexes or derivatives thereof; elemental selenium or its salts, complexes, derivatives or mixture thereof; and at least one surfactant when formulated in the form of water dispersible granules, water disintegrable granules or aqueous suspension with a specific particle size enhances the availability of nutrients for uptake by the plants which in turn results in improving the crop yield as well as in enhancing the crop physiological characteristics etc. The present composition was further observed to prevent the leaching of these nutrients and the synergy in the composition make them available to the fullest extent for the uptake by crops and increase the overall yield. Thus, it has been observed that the compositions of the present invention, demonstrate enhanced, efficacious and superior behaviour in the fields at reduced dosage.

It was further surprising to observe that the balanced uptake of nutrients leads to a healthier plant that could withstand pest infestation, a higher nutrient harvest in all soils types and finally improve the overall soil health. The present composition acts as a nutrient-use efficient composition while meeting the need of crops by providing a multi nutritive solution with improved uptake by crops at reduced dosage along with ease of application in the field making it economically beneficial and environment friendly.

### A. PREPARATION EXAMPLES

The following examples illustrate the basic methodology and versatility of the composition of the invention. It should be noted that this invention is not limited to these exemplifications. The form of the composition, excipients and the concentrations of actives and excipients can be replaced by any other forms, excipients and concentrations as covered in the present invention.

### Example 1: Elemental Sulphur 20%+Zinc Phosphate 18% (Zn 9.14%)+Selenium Dioxide 4% (Se 2.85%) Water Dispersible Granules (WDG)

20.3 parts of elemental Sulphur powder was blended with 18.4 parts of Zinc phosphate powder along with 4.3 parts of Selenium dioxide, 14 parts of bentonite, 29 parts of clay, 2 parts of Sodium lauryl sulphate, 10 parts of sodium ligno sulphonate and 1 parts of Sodium alkyl naphthalene sulfonate condensate in 100 parts of water and milled to average particle size below 4 micron. To the milled slurry under blending, 1 parts of sodium citrate was added and stirred for one hour, the material is then spray dried/fluid bed dried to obtain the granules.

The composition had the particle size of about 4 microns (D90) and about 1 microns (D50) and granule size of 0.05 mm to 1.5 mm. The composition had a suspensibility of 89%, wet sieve retention 0.05% on 75 micron sieve, degree of dispersion 85%, attrition resistance 95%, and wetting out time of 5 sec.

### Example 2: Elemental Sulphur 70%+Zinc Sulphide 19% (Zn 12.75%%)+Potassium Selenate 0.2% (Se 0.071%) Water Dispersible Granules (WDG)

71.5 parts of elemental Sulphur powder was blended with 19.2 parts of Zinc sulphide powder, along with 0.21 parts of Potassium selenate, 4.09 parts of blend of salt of naphthalene sulphonic acid and phenol sulphonic acid condensation product, 4 parts of sodium ligno sulphonate in 100 parts of water and milled to average particle size below 3 micron. To the milled slurry under blending, 1 parts of sodium citrate was added and stirred for one hour, the material is then spray dried/fluid bed dried to obtain the granule.

The composition had the particle size of about 5 microns (D90) and about 2 microns (D50) and granule size of 0.1 mm to 2 mm. The composition had a suspensibility of 90%, wet sieve retention 0.08% on 75 micron sieve, degree of dispersion 88%, attrition resistance 94%, and wetting out time of 5 sec.

### Example 3: Elemental Sulphur 90%+Zinc Oxide 0.14% (Zn 0.11%)+Selenium Dioxide 0.14% (Se 0.1%) Water Dispersible Granules (WDG)

91 parts of elemental Sulphur powder was blended with 0.145 parts of Zinc oxide powder along with 0.145 parts of Selenium dioxide, 3.21 parts of blend of salts of naphthalene sulphonic acid and phenol sulphonic acid condensation product, 5.5 parts of sodium ligno sulphonate in 100 parts of water and milled to average particle size below 3 micron. Milled slurry was then spray dried/fluid bed dried to obtain the granule.

The composition had the particle size of about 5 microns (D90) and about 3 microns (D50) and granule size of 0.1 mm to 2.5 mm. The composition had a suspensibility of 82%, wet sieve retention 0.05% on 75 micron sieve, degree of dispersion 76%, attrition resistance 92% and wetting out time 8 sec.

### Example 4: Elemental Sulphur 50%+Zinc Molybdate 18% (Zn 5.22%)+Selenium Dioxide 14% (Se 9.962%) Water Dispersible Granules (WDG)

51 parts of elemental Sulphur powder was blended with 18.4 parts of Zinc molybdate powder, along with 14.10 parts of Selenium dioxide, 3.9 parts of blend of salts of naphthalene sulphonic acid and phenol sulphonic acid condensation product, 10 parts of sodium ligno sulphonate along with 3 parts of sodium alkyl naphthalene sulfonate condensate in 100 parts of water and milled to average particle size below 3 micron. Milled slurry was then spray dried/fluid bed dried to obtain the granule.

The composition had the particle size of about 5 microns (D90) and about 2 microns (D50) and granule size of 0.1 mm to 2 mm. The composition had a suspensibility of 86%, wet sieve retention 0.02% on 75 micron sieve, degree of dispersion 81%, attrition resistance 94%, and wetting out time of 5 sec.

### Example 5: Elemental Sulphur 40%+Zinc carbonate 17% (Zn 8.87%)+Potassium selenate 25.7% (Se 9.17%) Water dispersible granules (WG)

41 parts of elemental Sulphur powder was blended with 17.2 parts of Zinc carbonate along with 25.9 parts of Potassium selenate, 3 parts of blend of salt of naphthalene sulphonic acid and phenol sulphonic acid condensation product, 10.30 parts of sodium ligno sulphonate in 100 parts of water and milled to average particle size below 2.5 micron. To the milled slurry under blending, 2.6 parts of sodium alkyl naphthalene sulfonate condensate is added and stirred for one hour, the material was then spray dried/fluid bed dried to obtain the granule.

The composition had the particle size of about 3 microns (D90) and about 1.5 microns (D50) and granule size of 0.05 mm to 1.5 mm. The composition had a suspensibility of 85%, wet sieve retention 0.09% on 75 micron sieve, degree of dispersion 80%, attrition resistance 94.3% and wetting out time 8 sec.

### Example 6: Elemental Sulphur 90%+Zinc Oxide 0.5% (Zn 0.40%)+Iron Selenide 0.25% (Se 0.146%) Water Dispersible Granules (WG)

91 parts of elemental Sulphur powder was blended with 0.58 parts of Zinc oxide, along with 0.26 parts of Iron selenide, 2.5 parts of mixture blend of salt of naphthalene sulphonic acid and phenol sulphonic acid condensation product, 2.66 parts of sodium ligno sulphonate in 100 parts of water and milled to average particle size below 4 micron. To the milled slurry under blending, additional quantity of 3 parts of sodium ligno sulphonate was added and stirred for one hour, the material was than spray dried/fluid bed dried to obtain the granule.

The composition had the particle size of about 5 microns (D90) and about 3 microns (D50), granule size of 0.1 mm to 3 mm, suspensibility 72%, Wet sieve retention 0.10% on 75 micron sieve, Degree of dispersion 68%, Attrition resistance 94.5%, wetting out time 10 sec.

### Example 7: Elemental Sulphur 1%+Zinc Carbonate 90% (Zn 46.94%)+Sodium Selenite 0.20% (Se 0.09%) Water Dispersible Granules (WG)

1.1 parts of elemental Sulphur powder was blended with 90.30 parts of Zinc carbonate, along with 0.21 parts of Sodium selenite, 4 parts of sodium ligno sulphonate, 2 parts of Kraft lignin,2.39 parts of sodium alkyl naphthalene sulfonate in 100 parts of water and milled to average particle size below 2 micron. Milled slurry was then spray dried/fluid bed dried to obtain the granule.

The composition had the particle size of about 2 microns (D90) and about 1 microns (D50), granule size of 0.1-1.5 mm suspensibility 82%, wet sieve retention 0.15% on 75 micron sieve, degree of dispersion 75%, attrition resistance 98.5%, wetting out time 7 sec.

### Example 8: Elemental Sulphur 10%+Zinc Oxide 45% (Zn 36%)+Iron Selenide 0.10% (Se 0.06%) Water Dispersible Granules (WG)

10.2 parts of elemental Sulphur powder was blended with 46.6 parts of Zinc oxide, along with 0.12 parts of Iron selenide, 12 parts of sodium ligno sulphonate, 3 parts of sodium alkyl naphthalene sulfonate, 28.08 parts of clay in 100 parts of water and milled to average particle size below 1.5 micron. Milled slurry was then spray dried/fluid bed dried to obtain the granule.

The composition had the particle size of about 1.5 microns (D90) and about 0.5 microns (D50), granule size of 0.05 mm to 2 mm, suspensibility 79%, Wet sieve retention 0.14% on 75 micron sieve, Degree of dispersion 71%, Attrition resistance 94.5%, wetting out time 15 sec.

### Example 9: Elemental Sulphur 20%+Zinc Oxide 18% (Zn 14.46%)+Iron Oxide 30% (Fe 23.32%)+Selenium Dioxide 2% (Se 1.423%) Water Dispersible Granules (WDG)

21 parts of elemental Sulphur powder was blended with 18.5 parts of Zinc oxide powder along with 2.10 parts of Selenium dioxide, 31 parts of iron oxide, 12 parts of bentonite, 5 parts of talc, 2 parts of Sodium lauryl sulphate, 4 parts of sodium ligno sulphonate, and 4.4 parts of sodium citrate in 100 parts of water and milled to average particle size below 4 micron. Milled slurry was then spray dried/fluid bed dried to obtain the granule.

The composition had the particle size of about 5 microns (D90) and about 3 microns (D50), granule size of 0.05 mm to 2 mm suspensibility 85%, Wet sieve retention 0.10% on 75 micron sieve, Degree of dispersion 75%, Attrition resistance 93.5%, wetting out time 10 sec.

### Example 10: Elemental Sulphur 65%+Zinc Oxide 18% (Zn 14.46%)+Selenium Dioxide 2% (Se 1.423%) Granules GR

65.85 parts of elemental Sulphur powder was blended with 18.4 parts of Zinc oxide powder along with 2 parts of Selenium dioxide, 2 parts of sodium citrate, 3.75 parts of clay, 2 parts of Sodium lauryl sulphate, 5 parts of sodium ligno sulphonate and 1 parts of sodium alkyl naphthalene sulfonate condensate in a Ribbon blender to obtain homogeneous powder. The mixture was then jet milled to obtain powder having particle size below 10 microns. 8 gms of water was added to this powder to prepare dough and the material was then granulated and dried to obtain the granules.

The composition had the particle size of about 20 microns (D90) and about 30 microns (D50) and granule size of 1-4 mm. The composition had an attrition resistance 99.7%.

### Example 11: Elemental Sulphur 80%+Zinc Sulphide 5% (Zn 3.36%)+Potassium Selenate 1% (Se 0.357%) Granules (GR)

80.9 parts of elemental Sulphur powder was blended with 5.2 parts of Zinc sulphide along with 1.1 parts of Potassium selenate, 5 parts of bentonite, 2 parts of Sodium lauryl sulphate, 5 parts of sodium ligno sulphonate and 0.8 parts of sodium alkyl naphthalene sulfonate condensate in a Ribbon blender to obtain homogeneous powder. The mixture was then jet milled to obtain powder having particle size below 10 microns. 11 gms of water was added to this mixture to prepare dough and the material was then granulated and dried to obtain the granules.

The composition had the particle size of about 20 microns (D90) and about 10 microns (D50) and granule size of 1 mm to 5 mm. The composition had an attrition resistance of 99.2%

### Example 12: Elemental Sulphur 1%+Zinc Oxide 50% (Zn 40.16%)+Selenium Dioxide 0.015% (Se 0.01%) Suspension Concentrate (SC)

15 parts of Polycarboxylate and 50 parts of propylene glycol were added to 300 parts of water and homogenized by feeding them into a vessel provided with stirring facilities. 11 parts of Sulphur powder, 504 parts of Zinc oxide, 0.15 parts of Selenium dioxide was further added to the homogenized blend and stirred continuously for approximately 10 minutes until the total mixture was homogeneous. To the above mixture, 10 parts of alkyl polyalkylene glycol ethers, 0.5 parts of polydimethylsiloxane emulsion was added under continuous homogenization to obtain liquid suspension. Subsequently, the suspension obtained was passed through the wet mill to reduce the particle size. Then, 1.4 parts of xanthan gum, 1 parts of 1,2-benzisothiazolin-3-one, balance water and 0.5 parts of polydimethylsiloxane emulsion were added under continuous homogenization to obtain the liquid suspension.

The composition had a particle size of (D10) 0.41 micron, (D50) 0.56 micron and (D90) 0.85 micron, viscosity of 600 cps and suspensibility of 95%. Pourability rinsed residue was found to be 0.58%. Spontaneity of dispersion 89%, wet sieve retention on 75 micron 0.05%

### Example 13: Elemental Sulphur 10%+Zinc Phosphate 30% (Zn 15.24%)+Selenium Dioxide 8% (Se 5.69%) Suspension Concentrate (SC)

5 parts of Polycarboxylate and 80 parts of propylene glycol were added to 300 parts of water and homogenized by feeding them into a vessel provided with stirring facilities. 102 parts of Sulphur powder, 304 parts of Zinc phosphate, 80 parts of Selenium dioxide were further added to the homogenized blend and stirred continuously for approximately 10 minutes until the total mixture was homogeneous. To the above mixture, 15 parts of alkyl polyalkylene glycol ethers, 2 parts of polymeric surfactant, 0.5 parts of polydimethylsiloxane emulsion was added under continuous homogenization to obtain liquid suspension. Subsequently, the suspension obtained was passed through the wet mill to reduce the particle size. Then, 1.2 parts of xanthan gum, 1 parts of 1,2-benzisothiazolin-3-one, balance water and 0.5 parts of polydimethylsiloxane emulsion were added under continuous homogenization to obtain the liquid suspension.

The composition had a particle size of (D10) 1.2 micron, (D50) 2.1 micron and (D90) 2.8 micron, viscosity of 550 cps and suspensibility of 93%. Pourability rinsed residue was found to be 0.48%, spontaneity of dispersion 87%, wet sieve retention on 75 micron 0.02%

### Example 14: Elemental Sulphur 55%+Zinc Carbonate 1% (Zn 0.52%)+Sodium Selenite 0.4% (Se 0.183%) Suspension Concentrate (SC)

20 parts of sodium alkyl naphthalene sulfonate condensate and 50 parts of propylene glycol were added to 300 parts of water and homogenized by feeding them into a vessel provided with stirring facilities. 560 parts of Sulphur powder, 11 parts of Zinc carbonate, 4.5 parts of Sodium selenite were further added to the homogenized blend and stirred continuously for approximately 10 minutes until the total mixture was homogeneous. To the above mixture, 10 parts of polyalkylene oxide modified heptamethyltrisiloxane, 0.5 parts of polydimethylsiloxane emulsion was added under continuous homogenization to obtain liquid suspension. Subsequently, the suspension obtained was passed through the wet mill to reduce the particle size. Then, 1.5 parts of xanthan gum, 1 parts of 1,2-benzisothiazolin-3-one, balance water and 0.5 parts of polydimethylsiloxane emulsion were added under continuous homogenization to obtain the liquid suspension.

The composition had a particle size of D10 1.45 micron D50 2.23 micron and D90 3.25 micron, viscosity of 800 cps and Suspensibility of 92%. Pourability rinsed residue was found to be 0.78%. Spontaneity of dispersion 85%, wet sieve retention on 75 micron 0.01%

### Example 15: Elemental Sulphur 1%+Zinc Carbonate 48% (Zn 25.03%)+Iron Selenide 1% (Se 0.586%) Suspension Concentrate (SC)

10 parts of alkyl polyalkeylene glycol ethers and 50 parts of ethylene glycol were added to 300 parts of water and homogenized by feeding them into a vessel provided with stirring facilities. 11 parts of Sulphur powder, 485 parts of Zinc carbonate, 11 parts of Iron selenide were further added to the homogenized blend and stirred continuously for approximately 10 minutes until the total mixture was homogeneous. To the above mixture, 10 parts of polycarboxylate, 0.4 parts of polydimethylsiloxane emulsion was added under continuous homogenization to obtain liquid suspension. Subsequently, the suspension obtained was passed through the wet mill to reduce the particle size. Then, 1.1 parts of xanthan gum, 1 parts of 1,2-benzisothiazolin-3-one, balance water and 0.4 parts of polydimethylsiloxane emulsion were added under continuous homogenization to obtain the liquid suspension.

The composition had a particle size of about 1.28 micron (D10) about 2.78 micron (D50) and about 3.895 micron (D90), viscosity of 520 cps and suspensibility of 96%. Pourability rinsed residue was found to be 0.52%. Spontaneity of dispersion 89%, wet sieve retention on 75 micron 0.03%

### Example 16: Elemental Sulphur 30%+Zinc Oxide 20% (Zn 16.06%)+Potassium Selenate 0.01% (Se 0.004%) Suspension Concentrate (SC)

35 parts of Anionic tristyrylphenol phosphate and 50 parts of ethylene glycol were added to 300 parts of water and homogenized by feeding them into a vessel provided with stirring facilities. 336 parts of Sulphur powder, 201 parts of Zinc oxide, 0.11 parts of Potassium selenate were further added to the homogenized blend and stirred continuously for approximately 10 minutes until the total mixture was homogeneous. To the above mixture, 0.4 parts of polydimethylsiloxane emulsion was added under continuous homogenization to obtain liquid suspension. Subsequently, the suspension obtained was passed through the wet mill to reduce the particle size. Then, 1.6 parts of xanthan gum, 1 parts of 1,2-benzisothiazolin-3-one, balance water and 0.4 parts of polydimethylsiloxane emulsion were added under continuous homogenization to obtain the liquid suspension.

The composition had a particle size of about 0.52 micron (D10) about 1.02 micron (D50) and about 2.23 micron (D90), viscosity of 680 cps and suspensibility of 94%, pourability rinsed residue was found to be 0.62%, spontaneity of dispersion 92%, wet sieve retention on 75 micron 0.01%.

### B. FIELD STUDY

Field trial 1: To study the synergistic effect of composition comprising elemental sulphur, water insoluble zinc and selenium in water dispersible granular (WDG) form on growth and yield in Tomato.

The field trials were carried out to study the effect of combination of elemental sulphur, water insoluble zinc and selenium in water dispersible granular form on growth and yield in Tomato crops. The trial was laid out during kharif season in Randomized Block Design (RBD) with eight treatments including untreated control, replicated four times. The test product samples with prescribed dose were applied as Top dressing at 30 days after transplanting of tomato crop. The tomato crop in trial field was raised following good agricultural practice.

Details of experiment

| | |
|---|---|
| Trial location | Chiloda, Gandhinagar |
| Crop: | Tomato |
| Trial Design | RBD, 04 replications |
| Plot size | 20 m × 3 m (60 Sq. m) |
| Date of transplanting | 20 Jun. 2022 |
| Type of application | Top dressing |
| Date of application | 20 Jul. 2022 (one application) |
| Assessment | Plant height, Plant vigor, Yield |

The observations on plant height was taken at 50 days after application from 10 randomly selected plants per treatment per replication and mean value was calculated. The plant vigor observations were taken at 50 days after application at 0-200% rating scale where UTC (untreated control) should be always 100%. The observations on yield were recorded at the time of harvesting and mean data is presented in Table 1.

TABLE 1

| | | | | | | | Yield | |
|---|---|---|---|---|---|---|---|---|
| | | | | | Plant | Plant | (T/ha) | |
| | | Active (elemental) | | | Height | vigor | Total | % |
| Sr. | Treatment | dosage (g/ha) | | | 50 DAA | 50 DAA | of 2 | Yield |
| no. | details | S | Zn | Se | (in cm) | (0-200) | pickings | increase |
| T1 | Elemental | 10500 | 2169 | 375 | 29.6 | 140 | 7.8 | 59.18 (*34.72) |
| | Sulphur 70% + | | | | | | | |
| | Zinc oxide | | | | | | | |
| | 18% (Zn | | | | | | | |
| | 14.46%) + | | | | | | | |
| | Potassium | | | | | | | |
| | selenite 6.5% | | | | | | | |
| | (Se 2.5%) | | | | | | | |
| | WDG as per | | | | | | | |
| | embodiment | | | | | | | |
| | of the present | | | | | | | |
| | invention | | | | | | | |
| | @15000 g/ha | | | | | | | |
| T2 | Elemental | 10500 | 2169 | 0 | 25.1 | 117 | 6.5 | 32.65 |
| | Sulphur 70% + | | | | | | | |
| | Zinc oxide | | | | | | | |
| | 18% (Zn | | | | | | | |
| | 14.46%) | | | | | | | |
| | WDG | | | | | | | |
| | @15000 g/ha | | | | | | | |
| T3 | Elemental | 10500 | 0 | 375 | 23.6 | 112 | 6.1 | 24.49 |
| | Sulphur 70% + | | | | | | | |
| | Potassium | | | | | | | |
| | selenite 6.5% | | | | | | | |
| | (Se 2.5%) | | | | | | | |
| | WDG | | | | | | | |
| | @15000 g/ha | | | | | | | |
| T4 | Zinc oxide | 0 | 2169 | 375 | 20.8 | 99 | 5.3 | 8.16 |
| | 18% (Zn | | | | | | | |
| | 14.46%) + | | | | | | | |
| | Potassium | | | | | | | |
| | selenite 6.5% | | | | | | | |
| | (Se 2.5%) | | | | | | | |
| | WDG | | | | | | | |
| | @15000 g/ha | | | | | | | |
| T5 | Elemental | 10500 | 0 | 0 | 23.4 | 111 | 6 | 22.45 |
| | Sulphur 70% | | | | | | | |
| | WDG | | | | | | | |
| | @15000 g/ha | | | | | | | |
| T6 | Zinc Oxide | 0 | 2169 | 0 | 20.8 | 102 | 5.5 | 12.24 |
| | 18% (Zn | | | | | | | |
| | 14.46%) | | | | | | | |
| | WDG | | | | | | | |
| | @15000 g/ha | | | | | | | |
| T7 | Potassium | 0 | 0 | 375 | 19.3 | 98 | 5.1 | 4.08 |
| | selenite 6.5% | | | | | | | |
| | (Se 2.5%) | | | | | | | |
| | WDG | | | | | | | |
| | @15000 g/ha | | | | | | | |
| T8 | Untreated | 0 | 0 | 0 | 18.8 | 100 | 4.9 | 0.00 |

*Expected percentage increase in yield
DAA—Days after Application

It is seen from table 1 that the Treatments T1 with the composition having combination of elemental sulphur, water insoluble zinc and selenium in WDG form prepared as per the embodiment of present invention demonstrate a synergistic effect in tomato crops.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

$$E = X + Y + Z - ( XY + YZ + XZ ) / 100 + ( XYZ / 10000 )$$

Where,
E=Expected % effect by mixture of two products X, Y and Z in a defined dose.
X=Observed % effect by product A
Y=Observed % effect by product B
Z=Observed % effect by product C

The synergy factor (SF) is calculated by Abbott's formula (Eq. (2) (Abbott, 1925).

$$SF = Observed effect / Expected effect$$

Where, SF>1 for Synergistic reaction; SF<1 for antagonistic reaction; SF=1 for additive reaction.

When the percentage of yield effect observed for the combination is greater than the expected percentage, synergistic effect of the combination can be inferred. When the percentage of yield effect observed for the combination is equal to the expected percentage, merely an additive effect may be inferred and wherein the percentage of yield effect observed for the combination is lower than the expected percentage, an antagonistic effect of the combinations can be inferred.

It can be observed from Table 1 that Treatment T1 with WDG compositions of elemental Sulphur 70%+Zinc oxide 18% (Zn 14.46%)+Potassium selenite 6.5% (Se 2.5%), was highly effective and demonstrated increased yield of tomato as compared to the two-way combination treatments (T2, T3 and T4), and individual treatments of the actives (T5, T6 and T7). It can be seen that the treatments T1 to T7 were applied at same active dosage i.e. 10500 gm/ha of elemental sulphur, 2169 gm/ha of zinc and 375 gm/ha of selenium. The expected % increase in yield calculated using Colby's formula for T1 was 34.72% whereas the observed % increase in yield for Treatment T1 was 59.18%. Thus, the synergy factor for treatment T1 is 1.7 which indicates synergistic effect.

It can be appreciated from the observed results that plant height and plant vigor in Tomato crop were higher in treatment T1 as compared to the two-way combination treatments and individual treatments of the actives. It was also observed that the leaves of tomato plot treated with treatments T1 were greener as compared to Treatments T2-T7 and the untreated plot where yellow leaves were observed.

Thus, the combination of elemental Sulphur 70%+Zinc oxide 18%+Potassium selenite 6.5% in WDG form as per embodiment of the present invention is synergistic and provides higher crop yield and improved growth parameters as compared to the application of individual actives and two way combinations when applied at the same dosage. The surprising synergistic result of treatment T1 is attributed to the composition comprising elemental sulphur, water insoluble zinc and selenium as per the embodiments of the invention, where all three nutrients are present in a single composition at a specific concentration.

Field trial 2: To study the synergistic effect of composition comprising elemental sulphur, water insoluble zinc and selenium in water disintegrable granular (GR) form on growth and yield in Brinjal.

The trial was laid out during Kharif season in Randomized Block Design (RBD) with eight treatments including untreated control, replicated four times. For each treatment, plot size of 40 sq. m (8 m×5 m) was maintained. The compositions evaluated include elemental sulphur, water insoluble zinc and selenium in combination and alone. The Brinjal crop in the trial field was raised following good agricultural practices. The seeds of Brinjal, Pusa purple long, were used for the study and planted in 120 cm row to row and 45 cm plant to plant spacing. The details of the experiment are as follows:

Details of experiment

| | |
|---|---|
| Trial location | Nasik (MH) |
| Crop: | Brinjal, (Pusa purple long) |
| Experiment season | Kharif |
| Trial Design | Randomized Block Design |
| Replications | Four |
| Plot size | 8 m × 5 m = 40 sq. m |
| Type of application | Broadcasting in furrow |
| Date of transplanting | 22 Jul. 2022 |
| Date of application | 22 Jul. 2022 (one application) |
| Date of Pickings | 5 Nov. 2022, 15 Nov. 2022, 20 Nov. 2022 |

The observations for number of fruits were taken at 60 DAA from 10 randomly selected plants per treatment per replication and mean value was calculated. The plant vigor observations were taken at 50 days after application at 0-200% rating scale where UTC (untreated control) should be always 100%. The observations on yield were recorded at the time of harvesting and mean data is presented in Table 2.

TABLE 2

| | | | | | | | Yield | |
|---|---|---|---|---|---|---|---|---|
| | | | | | No. of | Plant | (T/ha) | |
| | | Active dosage | | | Fruits | vigor | Total | % |
| Sr. | Treatment | (Elemental) (g/ha) | | | per plant | (0-200) | of 3 | yield |
| no. | Details | S | Zn | Se | at 60 DAA | at 50 DAA | pickings | increase |
| T1 | Sulphur 50% + | 15000 | 1566 | 264 | 17 | 148 | 10.1 | 55.38 (*30.81) |
| | Zinc carbonate | | | | | | | |
| | 10% (Zn 5.22%) + | | | | | | | |
| | Potassium | | | | | | | |
| | selenite 2.29% | | | | | | | |
| | (Se 0.88%) GR | | | | | | | |
| | as per | | | | | | | |
| | embodiment of | | | | | | | |
| | the invention | | | | | | | |
| | @30000 g/ha | | | | | | | |
| T2 | Elemental | 15000 | 1566 | 0 | 15 | 130 | 8.5 | 30.77 |
| | Sulphur 50% + | | | | | | | |
| | Zinc Carbonate | | | | | | | |
| | 10% (Zn 5.22%) | | | | | | | |
| | GR @30000 | | | | | | | |
| | g/ha | | | | | | | |
| T3 | Elemental | 15000 | 0 | 264 | 13 | 127 | 8.0 | 23.08 |
| | Sulphur 50% + | | | | | | | |
| | Potassium | | | | | | | |
| | selenite 2.29% | | | | | | | |
| | (Se 0.88%) GR | | | | | | | |
| | @30000 g/ha | | | | | | | |
| T4 | Zinc Carbonate | 0 | 1566 | 264 | 11 | 108 | 7.3 | 12.31 |
| | 10% (Zn 5.22%) + | | | | | | | |
| | Potassium | | | | | | | |
| | selenite 2.29% | | | | | | | |
| | (Se 0.88%) GR | | | | | | | |
| | @30000 g/ha | | | | | | | |
| T5 | Sulphur 50% | 15000 | 0 | 0 | 13 | 120 | 7.8 | 20.00 |
| | GR @30000 | | | | | | | |
| | g/ha | | | | | | | |
| T6 | Zinc Carbonate | 0 | 1566 | 0 | 11 | 109 | 7.2 | 10.77 |
| | 10% (Zn 5.22%) | | | | | | | |
| | GR @30000 | | | | | | | |
| | g/ha | | | | | | | |
| T7 | Potassium | 0 | 0 | 264 | 10 | 101 | 6.7 | 3.08 |
| | selenite 2.29% | | | | | | | |
| | (Se 0.88%) GR | | | | | | | |
| | @30000 g/ha | | | | | | | |
| T8 | Untreated | 0 | 0 | 0 | 9 | 100 | 6.5 | 0.00 |

*Expected percentage yield increase

It can be observed from Table 2 that Treatment T1 with GR compositions of “Sulphur 50%+Zinc carbonate 10% (Zn 5.22%)+Potassium selenite 2.29% (Se 0.88%)”, was highly effective and demonstrated increased yield of Brinjal as compared to the two-way combination treatments (T2, T3 and T4), and individual treatments of the actives (T5, T6 and T7). It can be seen that the treatments T1 to T7 were applied at same active dosage i.e. 15000 gm/ha of elemental sulphur, 1566 gm/ha of zinc and 264 gm/ha of selenium. The expected % increase in yield calculated using Colby's formula for T1 was 30.81% whereas the observed % increase in yield for Treatment T1 was 55.38%. Thus, the synergy factor for treatment T1 is 1.8 indicating synergistic effect.

It can be appreciated from the observed results that number of fruits per plant and plant vigor in brinjal crop were higher in treatment T1 as compared to the two-way combination treatments and individual treatments of the actives. It was also observed that other plant growth parameters such as plant height, number of branches, greenness of the leaves of brinjal plot for treatments T1 were superior as compared to Treatments T2-T7 and the untreated plot where yellow leaves, stunted plant growth was observed.

Thus, the combination of Sulphur 50%+Zinc carbonate 10%+Potassium selenite 2.29% in GR form as per embodiment of the present invention is synergistic and provides higher crop yield and improved growth parameters as compared to the application of individual actives and two way combinations when applied at the same dosage. The surprising synergistic result of treatment T1 is attributed to the composition comprising elemental sulphur, water insoluble zinc and selenium as per the embodiments of the invention, where all three nutrients are present in a single composition at a specific concentration.

Field trial 3: To study the synergistic effect of composition comprising elemental sulphur, water insoluble zinc and selenium in aqueous suspension (SC) form on growth and yield in Okra.

The trial was laid out during Kharif season in Randomized Block Design (RBD) with eight treatments including untreated control, replicated four times. For each treatment, plot size of 40 sq. m (8 m×5 m) was maintained. The compositions evaluated include elemental sulphur, water insoluble zinc and selenium in combination and alone. The Okra crop in the trial field was raised following good agricultural practices. The seeds of Okra, Kumkum, Advanta seeds were used for the study and planted in 120 cm row to row and 45 cm plant to plant spacing. The details of the experiment are as follows:

Details of experiment

| | |
|---|---|
| Trial location | Nasik (MH) |
| Crop: | Okra, (Variety Kumkum, Advanta seeds) |
| Experiment season | Kharif |
| Trial Design | Randomized Block Design |
| Replications | Four |
| Plot size | 8 m × 5 m = 40 sq. m |
| Type of application | Drip irrigation |
| Water volume used: | 500 L/ha |
| Date of transplanting | 15 Jul. 2022 |
| Date of application | 15 Jul. 2022 (one application) |
| Date of Pickings | 29 Oct. 2022, 7 Nov. 2022, 13 Nov. 2022 |

The observations on plant height was taken at 50 DAA from 10 randomly selected plants per treatment per replication and mean value was calculated. The observations on yield were recorded at the time of harvesting and mean data is presented in Table 3.

TABLE 3

| | | | | | Plant | Yield | |
|---|---|---|---|---|---|---|---|
| | | Active dosage | | | Height | (T/ha) | % |
| Sr. | Treatment | (elemental) (g/ha) | | | (in cm) - | Total of | yield |
| no. | Details | S | Zn | Se | 50 DAA | 3 pickings | increase |
| T1 | Elemental | 13750 | 1150 | 161 | 38 | 6.3 | 57.50 (*29.46) |
| | Sulphur 25% + | | | | | | |
| | Zinc carbonate | | | | | | |
| | 4% (Zn 2.09%) + | | | | | | |
| | Iron selenide | | | | | | |
| | 0.5% (Se 0.293%) | | | | | | |
| | SC as per | | | | | | |
| | embodiment of | | | | | | |
| | the present | | | | | | |
| | invention | | | | | | |
| | @55000 g/ha | | | | | | |
| T2 | Elemental | 13750 | 1150 | 0 | 34.1 | 5.1 | 27.50 |
| | Sulphur 25% + | | | | | | |
| | Zinc Carbonate | | | | | | |
| | 4% (Zn 2.09%) | | | | | | |
| | SC @55000 g/ha | | | | | | |
| T3 | Elemental | 13750 | 0 | 161 | 32.2 | 4.9 | 22.50 |
| | Sulphur 25% + | | | | | | |
| | Iron selenide | | | | | | |
| | 0.5% (Se 0.293%) | | | | | | |
| | SC @55000 g/ha | | | | | | |
| T4 | Zinc carbonate | 0 | 1150 | 161 | 28.5 | 4.5 | 12.50 |
| | 4% (Zn 2.09%) + | | | | | | |
| | Iron selenide | | | | | | |
| | 0.5% (Se 0.293%) | | | | | | |
| | SC @55000 g/ha | | | | | | |
| T5 | Elemental | 13750 | 0 | 0 | 31.5 | 4.7 | 17.50 |
| | Sulphur 25% SC | | | | | | |
| | @55000 g/ha | | | | | | |
| T6 | Zinc carbonate | 0 | 1150 | 0 | 27.1 | 4.4 | 10.00 |
| | 4% (Zn 2.09%) | | | | | | |
| | SC @55000 g/ha | | | | | | |
| T7 | Iron selenide | 0 | 0 | 161 | 26 | 4.2 | 5.00 |
| | 0.5% (Se 0.293%) | | | | | | |
| | SC @55000 g/ha | | | | | | |
| T8 | Untreated | 0 | 0 | 0 | 24.2 | 4 | 0.00 |

*expected percentage yield increase

It can be observed from Table 3 that Treatment T1 with an aqueous suspension compositions of “Sulphur 25%+Zinc carbonate 4% (Zn 2.09%)+Iron selenide 0.5% (Se 0.293%)”, was highly effective and demonstrated increased yield of Okra as compared to the two-way combination treatments (T2, T3 and T4), and individual treatments of the actives (T5, T6 and T7). It can be seen that the treatments T1 to T7 were applied at same active dosage i.e. 13750 gm/ha of elemental sulphur, 1150 gm/ha of zinc and 161 gm/ha of selenium. The expected % increase in yield calculated using Colby's formula for T1 was 29.46% whereas the observed % increase in yield for Treatment T1 was 57.50%. Thus, the synergy factor for treatment T1 is 1.95 indicating synergistic effect.

It can be appreciated from the observed results that plant height in Okra crop were higher in treatment T1 as compared to the two-way combination treatments and individual treatments of the actives.

Thus, the combination of elemental Sulphur 25%+Zinc carbonate 4%+Iron selenide 0.5% in an aqueous suspension form as per embodiment of the present invention is synergistic and provides higher crop yield and improved growth parameters as compared to the application of individual actives and two way combinations when applied at the same dosage. The surprising synergistic result of treatment T1 is attributed to the composition comprising homogenous mixture of elemental sulphur, water insoluble zinc and selenium as per the embodiments of the invention, where all three nutrients are present in a single composition at a specific concentration.

Field trial 4: To study the effect of particle size distribution in the composition comprising elemental sulphur, water insoluble zinc and selenium in Tomato.

The trial was laid out during Rabi season in Randomized Block Design (RBD) with twelve treatments including untreated control, replicated four times. For each treatment, plot size of 40 sq. m (8 m×5 m) was maintained. The compositions evaluated include elemental sulphur, water insoluble zinc and selenium in combination and alone. The Tomato crop in the trial field was raised following good agricultural practices. The seeds of Tomato, Abhilash, were used for the study and planted in 120 cm row to row and 45 cm plant to plant spacing. The details of the experiment are as follows:

Details of experiment

| | |
|---|---|
| Trial location | Nasik (MH) |
| Crop: | Tomato (variety Abhilash) |
| Experiment season | Rabi |
| Trial Design | Randomized Block Design |
| Replications | Four |
| Plot size | 8 m × 5 m = 40 sq. m |
| Type of application | Basal in furrow |
| Date of transplanting | 5 Jan. 2023 |
| Date of application | 5 Jan. 2023 (one application) |
| Date of Pickings | 20 Apr. 2023, 30 Apr. 2023, 5 May 2023 |

The nutrient uptake was measured at 90 days after application by picking leaves and analyzing the nutrient content in lab. The yield observations were recorded at the harvesting time and the mean data was presented in Table 4 to enumerate the efficacy of the compositions of elemental sulphur, water insoluble zinc and selenium with the particles in the size range of 0.1 to 30 microns prepared as per the embodiment of the present invention vis-ai-vis compositions having particle size beyond 0.1 to 30 microns.

TABLE 4

| | | | | | | Yield | % yield |
|---|---|---|---|---|---|---|---|
| | | | Active dosage | | | (T/ha) | increase |
| Sr. | Treatment | Particle | (Elemental) (g/ha) | | | Total of | over |
| no. | details | size | S | Zn | Se | 3 pickings | control |
| T1 | Sulphur 40% + | 0.1-10 | 8000 | 1778 | 175 | 8.7 | 45.00 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG as per | | | | | | |
| | embodiment of | | | | | | |
| | the present | | | | | | |
| | invention | | | | | | |
| | @20000 g/ha | | | | | | |
| T2 | Sulphur 40% + | 0.1-30 | 10000 | 2223 | 219 | 8.1 | 35.00 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG as per | | | | | | |
| | embodiment of | | | | | | |
| | the present | | | | | | |
| | invention | | | | | | |
| | @25000 g/ha | | | | | | |
| T3 | Sulphur 65% + | 0.1-30 | 10000 | 2225 | 219 | 7.9 | 31.67 (*27.5) |
| | Zinc oxide 18% | | | | | | |
| | (Zn14.46%) + | | | | | | |
| | Selenium | | | | | | |
| | dioxide 2% (Se | | | | | | |
| | 1.42%) WDG as | | | | | | |
| | per embodiment | | | | | | |
| | of the present | | | | | | |
| | invention | | | | | | |
| | @15385 g/ha | | | | | | |
| T4 | Sulphur 40% + | 31-50 | 10000 | 2223 | 219 | 6.9 | 15.00 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG@25000 | | | | | | |
| | g/ha | | | | | | |
| T5 | Sulphur 40% + | 0.1-50 | 10000 | 2223 | 219 | 7.4 | 23.33 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG @25000 | | | | | | |
| | g/ha | | | | | | |
| T6 | Sulphur 40% + | 0.1-100 | 10000 | 2223 | 219 | 7 | 16.67 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG @25000 | | | | | | |
| | g/ha | | | | | | |
| T7 | Sulphur 40% + | 100-300 | 10000 | 2223 | 219 | 6.5 | 8.33 (*27.5) |
| | Zinc Molybdate | | | | | | |
| | 30.6% (Zn | | | | | | |
| | 8.89%) + | | | | | | |
| | Potassium | | | | | | |
| | selenate 2.45% | | | | | | |
| | (Se 0.874%) | | | | | | |
| | WDG @25000 | | | | | | |
| | g/ha | | | | | | |
| T8 | Sulphur 65% + | 0.1-50 | 10000 | 2225 | 219 | 7.2 | 20.00 (*27.5) |
| | Zinc Oxide 18% | | | | | | |
| | (Zn 14.46%) + | | | | | | |
| | Selenium | | | | | | |
| | dioxide 2% (Se | | | | | | |
| | 1.42%) WDG | | | | | | |
| | @15385 g/ha | | | | | | |
| T9 | Sulphur 40% | 0.1-30 | 10000 | 0 | 0 | 7 | 16.67 |
| | WDG @25000 | | | | | | |
| | g/ha | | | | | | |
| T10 | Zinc Molybdate | 0.1-30 | 0 | 2223 | 0 | 6.6 | 10.00 |
| | 30.6% (Zn | | | | | | |
| | 8.89%) WDG | | | | | | |
| | @25000 g/ha | | | | | | |
| T11 | Potassium | 0.1-30 | 0 | 0 | 219 | 6.2 | 3.33 |
| | selenate 2.45% | | | | | | |
| | (Se 0.874%) | | | | | | |
| | WDG @25000 | | | | | | |
| | g/ha | | | | | | |
| T12 | Untreated | 0 | 0 | 0 | 0 | 6 | 0.00 |

| | | | | |
|---|---|---|---|---|
| | | | Active dosage | Nutrient uptake |
| Sr. | Treatment | Particle | (Elemental) (g/ha) | (PPM or mg/kg) |

| No. | details | size | S | Zn | Se | S | Zn | Se |
|---|---|---|---|---|---|---|---|---|
| T1 | Sulphur 40% + | 0.1-10 | 8000 | 1778 | 175 | 354 | 13.4 | 0.0058 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG as per | | | | | | | |
| | embodiment of | | | | | | | |
| | the present | | | | | | | |
| | invention | | | | | | | |
| | @20000 g/ha | | | | | | | |
| T2 | Sulphur 40% + | 0.1-30 | 10000 | 2223 | 219 | 334 | 12.9 | 0.0052 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG as per | | | | | | | |
| | embodiment of | | | | | | | |
| | the present | | | | | | | |
| | invention | | | | | | | |
| | @25000 g/ha | | | | | | | |
| T3 | Sulphur 65% + | 0.1-30 | 10000 | 2225 | 219 | 320 | 12.6 | 0.0048 |
| | Zinc oxide 18% | | | | | | | |
| | (Zn14.46%) + | | | | | | | |
| | Selenium | | | | | | | |
| | dioxide 2% (Se | | | | | | | |
| | 1.42%) WDG as | | | | | | | |
| | per embodiment | | | | | | | |
| | of the present | | | | | | | |
| | invention | | | | | | | |
| | @15385 g/ha | | | | | | | |
| T4 | Sulphur 40% + | 31-50 | 10000 | 2223 | 219 | 302 | 11.1 | 0.0039 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG @25000 | | | | | | | |
| | g/ha | | | | | | | |
| T5 | Sulphur 40% + | 0.1-50 | 10000 | 2223 | 219 | 307 | 11.7 | 0.0042 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG @25000 | | | | | | | |
| | g/ha | | | | | | | |
| T6 | Sulphur 40% + | 0.1-100 | 10000 | 2223 | 219 | 303 | 11.4 | 0.0040 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG @25000 | | | | | | | |
| | g/ha | | | | | | | |
| T7 | Sulphur 40% + | 100-300 | 10000 | 2223 | 219 | 296 | 10.8 | 0.0023 |
| | Zinc Molybdate | | | | | | | |
| | 30.6% (Zn | | | | | | | |
| | 8.89%) + | | | | | | | |
| | Potassium | | | | | | | |
| | selenate 2.45% | | | | | | | |
| | (Se 0.874%) | | | | | | | |
| | WDG @25000 | | | | | | | |
| | g/ha | | | | | | | |
| T8 | Sulphur 65% + | 0.1-50 | 10000 | 2225 | 219 | 305 | 11.5 | 0.004 |
| | Zinc Oxide 18% | | | | | | | |
| | (Zn 14.46%) + | | | | | | | |
| | Selenium | | | | | | | |
| | dioxide 2% (Se | | | | | | | |
| | 1.42%) WDG | | | | | | | |
| | @15385 g/ha | | | | | | | |
| T9 | Sulphur 40% | 0.1-30 | 10000 | 0 | 0 | 300 | 10.9 | 0.0039 |
| | WDG @25000 | | | | | | | |
| | g/ha | | | | | | | |
| T10 | Zinc Molybdate | 0.1-30 | 0 | 2223 | 0 | 288 | 11 | 0.0036 |
| | 30.6% (Zn | | | | | | | |
| | 8.89%) WDG | | | | | | | |
| | @25000 g/ha | | | | | | | |
| T11 | Potassium | 0.1-30 | 0 | 0 | 219 | 283 | 10.2 | 0.004 |
| | selenate 2.45% | | | | | | | |
| | (Se 0.874%) | | | | | | | |
| | WDG @25000 | | | | | | | |
| | g/ha | | | | | | | |
| T12 | Untreated | 0 | 0 | 0 | 0 | 280 | 10.1 | 0.0034 |

*expected percentage yield increase

It can be seen from the data presented in Table 4 that the treatments with the compositions comprising elemental sulphur, water insoluble zinc and selenium as per the embodiment of the present invention with particles of the composition in the size range of 0.1 to 30 microns i.e. T1 to T3 illustrated significant increase in yield as well as nutrient uptake as compared to the same compositions having particles in the size range beyond 0.1 to 30 microns i.e. T4 to T8. For instance, treatment T2 with the composition comprising Sulphur 40%+Zinc Molybdate 30.6% (Zn 8.89%)+Potassium selenate 2.45% (Se 0.874%) WG with the particle size in the range of 0.1-30 microns as per embodiment of the present invention demonstrated yield increase of around 35% over control which is higher than the expected yield increase calculated as per Colby's formula i.e. 27.5% whereas treatments with the compositions having the particle size beyond 0.1-30 microns (T4 to T7) showed yield increase of only between 8% to 24% which is also lower than the expected yield increase. Similarly, treatments with the composition of the present invention demonstrated superior nutrient uptake as compared to other treatments. Thus, it can be seen that the superior and synergistic efficacy is observed when the particles of the composition are in the range of 0.1-30 microns.

The results are all the more surprising as the treatments T2 and T4 to T7 comprising combination of elemental sulphur, water insoluble zinc and selenium with different particle size ranges and standalone treatments T9 to T11 were applied at almost the same dosage of actives to the soil i.e. at a dosage of about 10000 g/ha of sulphur, about 2223 g/ha of zinc and about 219 g/ha of selenium.

Further it can be seen from the above table that the treatment T1 with the composition as per the embodiment of the present invention with the particles in the size range of 0.1 to 10 microns demonstrated highest yield and nutrient uptake even though it has been applied at reduced dosage as compared to other treatments.

It can be observed that the composition having particles in the size range of 0.1 to 30 microns facilitated the increased availability of the nutrients present in the composition for uptake by the crops at reduced dosages of application.

Thus, it can be concluded that the composition comprising of elemental sulphur, water insoluble zinc and selenium with the particles in the size range of 0.1 to 30 microns is synergistic in nature and demonstrated significantly higher uptake of nutrients and higher yield at reduced dosage. Thus, a composition of present invention in the form of a claimed composition was found to be highly nutrient-use efficient and commercially economical and environment friendly.

Field trial 5: To study the efficacy of composition comprising elemental sulphur, water insoluble zinc and selenium as compared to individual active at reduced dosage in Cowpea.

The trial was laid out during rainy season in Randomized Block Design (RBD) with nine treatments including untreated control, replicated four times. For each treatment, plot size of 40 sq. m (8 m×5 m) was maintained. The compositions evaluated include elemental sulphur, water insoluble zinc and selenium in combination and alone along with market standard, Yaramila fertilizer product (comprising Nitrogen 20%+P2O5−4.5%+K2O 7.5%+Se 0.0015%) and traditional fertilizer practice (NPK). The cowpea crop in the trial field was raised following good agricultural practices. The seeds of cowpea, Gomati (UV-89), were used for the study and planted in 120 cm row to row and 45 cm plant to plant spacing. The details of the experiment are as follows:

Details of experiment

| | |
|---|---|
| Trial location | Umargaon, Maharshtra |
| Crop: | Cowpeas- variety Gomati (UV-89) |
| Experiment season | Rainy |
| Trial Design | Randomized Block Design |
| Replications | Four |
| Plot size | 40 sq. m (8 m × 5 m) |
| Type of application | Basal Dose (near root zone) |
| Trial period | 7 Jun. 2022 to 2 Aug. 2022 |
| Observations | 30 DAA, 75 DAA |

The observations for plant growth parameters were recorded at 30DAA and 75DAA and for yield at the harvesting time and the mean data was presented in Table 5 to enumerate the efficacy of the compositions of elemental sulphur, water insoluble zinc and selenium in water dispersible granular form prepared as per the embodiment of the present invention and applied at reduced dosage as compared to standalone actives.

TABLE 5

| | | | | | Observations | | | | |
|---|---|---|---|---|---|---|---|---|---|
| | | | | | | | No. of | No. of | |
| | | | | | | Plant | pods | root | Plant |
| | | Active (elemental) | | | Greenness | Height | per | nodules/ | vigor |
| Sr. | Treatment | dosage (g/ha) | | | (0-4) | (in cm) | plant | plant | (0-200) |
| No. | details | S | Zn | Se | at 30 DAA | at 75 DAA | 75 DAA | at 75 DAA | at 75 DAA |
| T1 | Elemental | 10800 | 1126 | 158 | 4 | 21 | 24 | 53 | 148 |
| | Sulphur 60% + | | | | | | | | |
| | Zinc | | | | | | | | |
| | carbonate | | | | | | | | |
| | 12% (Zn | | | | | | | | |
| | 6.26%) + | | | | | | | | |
| | Iron selenide | | | | | | | | |
| | 1.5% (Se | | | | | | | | |
| | 0.88%) WG | | | | | | | | |
| | as per | | | | | | | | |
| | embodiment | | | | | | | | |
| | of the present | | | | | | | | |
| | invention | | | | | | | | |
| | @18000 g/ha | | | | | | | | |
| T2 | Sulphur 85% + | 15300 | 1446 | 227 | 4 | 21 | 23 | 51 | 140 |
| | Zinc Oxide | | | | | | | | |
| | 10% (Zn | | | | | | | | |
| | 8.03%) + | | | | | | | | |
| | Selenium | | | | | | | | |
| | dioxide | | | | | | | | |
| | 1.77% (Se | | | | | | | | |
| | 1.26%) GR | | | | | | | | |
| | as per | | | | | | | | |
| | embodiment | | | | | | | | |
| | of the present | | | | | | | | |
| | invention | | | | | | | | |
| | @18000 g/ha | | | | | | | | |
| T3 | Sulphur 35% + | 6300 | 1372 | 208 | 3 | 19 | 22 | 49 | 137 |
| | Zinc | | | | | | | | |
| | Phosphate | | | | | | | | |
| | 15% (Zn | | | | | | | | |
| | 7.62%) + | | | | | | | | |
| | Potassium | | | | | | | | |
| | Selenite 3% | | | | | | | | |
| | (Se 1.15%) | | | | | | | | |
| | SC as per | | | | | | | | |
| | embodiment | | | | | | | | |
| | of the present | | | | | | | | |
| | invention @ | | | | | | | | |
| | 18000 g/ha | | | | | | | | |
| T4 | Elemental | 17000 | 0 | 0 | 2 | 17 | 18 | 38 | 120 |
| | Sulphur 85 | | | | | | | | |
| | GR @20000 | | | | | | | | |
| | g/ha | | | | | | | | |
| T5 | Zinc oxide | 0 | 1606 | 0 | 2 | 16 | 17 | 25 | 113 |
| | 10% (Zn | | | | | | | | |
| | 8.03%) GR | | | | | | | | |
| | @20000 g/ha | | | | | | | | |
| T6 | Selenium | 0 | 0 | 252 | 1 | 15 | 15 | 17 | 99 |
| | Oxide 1.77% | | | | | | | | |
| | (Se 1.26%) | | | | | | | | |
| | GR @20000 | | | | | | | | |
| | g/ha | | | | | | | | |
| T7 | Yaramila | | | | 3 | 17 | 19 | 40 | 122 |
| | @225000 | | | | | | | | |
| | g/ha | | | | | | | | |
| T8 | NPK | | | | 3 | 16 | 18 | 30 | 120 |
| | @125000 | | | | | | | | |
| | g/ha in 3 | | | | | | | | |
| | split | | | | | | | | |
| | applications | | | | | | | | |
| T9 | Untreated | 0 | 0 | 0 | 0 | 14 | 15 | 17 | 100 |

| | |
|---|---|
| Active (elemental) | Observations |

| Sr. | | dosage (g/ha) | | | Yield | % yield |
|---|---|---|---|---|---|---|
| no. | Treatment details | S | Zn | Se | (T/ha) | increase |
| T1 | Elemental Sulphur | 10800 | 1126 | 158 | 1.5 | 36.36 |
| | 60% + Zinc | | | | | |
| | carbonate 12% (Zn | | | | | |
| | 6.26%) + Iron | | | | | |
| | selenide 1.5% (Se | | | | | |
| | 0.88%) WG as per | | | | | |
| | embodiment of the | | | | | |
| | present invention | | | | | |
| | @18000 g/ha | | | | | |
| T2 | Sulphur 85% + Zinc | 15300 | 1446 | 227 | 1.48 | 34.55 |
| | Oxide 10% (Zn | | | | | |
| | 8.03%) + Selenium | | | | | |
| | dioxide 1.77% (Se | | | | | |
| | 1.26%) GR as per | | | | | |
| | embodiment of the | | | | | |
| | present invention | | | | | |
| | @18000 g/ha | | | | | |
| T3 | Sulphur 35% + Zinc | 6300 | 1372 | 208 | 1.39 | 26.36 |
| | Phosphate 15% (Zn | | | | | |
| | 7.62%) + Potassium | | | | | |
| | Selenite 3% (Se | | | | | |
| | 1.15%) SC as per | | | | | |
| | embodiment of the | | | | | |
| | present invention @ | | | | | |
| | 18000 g/ha | | | | | |
| T4 | Elemental Sulphur | 17000 | 0 | 0 | 1.3 | 18.18 |
| | 85% GR @20000 | | | | | |
| | g/ha | | | | | |
| T5 | Zinc oxide 10% (Zn | 0 | 1606 | 0 | 1.19 | 8.18 |
| | 8.03%) GR @20000 | | | | | |
| | g/ha | | | | | |
| T6 | Selenium Oxide | 0 | 0 | 252 | 1.12 | 1.82 |
| | 1.77% (Se 1.26%) | | | | | |
| | GR @20000 g/ha | | | | | |
| T7 | Yaramila @225000 | | | | 1.33 | 20.91 |
| | g/ha | | | | | |
| T8 | NPK @125000 g/ha | | | | 1.28 | 16.36 |
| | in 3 split | | | | | |
| | applications | | | | | |
| T9 | Untreated | 0 | 0 | 0 | 1.1 | 0.00 |

From the data presented in the Table 5, it can be seen that the treatments T1 to T3 with the compositions as per the embodiments of the present invention comprising combination of elemental sulphur, water insoluble zinc and selenium demonstrated higher yield along with improved growth parameters such as greenness, plant height, number of pods, number of root nodules, plant vigor etc. even at reduced active dosage as compared to stand alone application of actives and market standard as well as traditional fertilizer practice.

It can be seen that treatment T1 with the composition of the present invention comprising Elemental Sulphur 60%+Zinc carbonate 12% (Zn 6.26%)+Iron selenide 1.5% (Se 0.88%) WG with dosage of sulphur @10800 g/ha+zinc @1126 g/ha+selenium @158 g/ha showed 36.36% increase in yield over untreated plot whereas individual treatment with sulphur @17000 g/ha (T4), zinc @1606 g/ha (T5) and selenium @252 g/ha (T6) showed increase in yield of only 18.18%, 8.18% and 1.82% respectively. Similar results were observed with treatments T2-T3. The results are all the more surprising as the treatments T1-T3 comprising combination of elemental sulphur, water insoluble zinc and selenium were applied at reduced active dosage as compared to standalone treatments T4-T6.

Further it can be seen from the above table that the treatment T1 to T3 with the composition as per the embodiment of the present invention demonstrated superior yield and plant growth as compared to market standard, Yaramila fertilizer product (comprising Nitrogen 20%+P2O5 p4.5%+K2O 7.5%+Se 0.0015%) (T7) and traditional fertilizer practice, NPK (T8).

From the aforementioned data, it can be concluded that the composition comprising of elemental sulphur, water insoluble zinc and selenium in WDG form with the particles in the size range of 0.1 to 30 microns provides surprisingly higher field efficacy at reduced dosages of application of the composition making it commercially economical and environment friendly.

Field trial 6: To assess the efficacy of different formulations of elemental sulphur, water insoluble zinc and selenium in Tomato:

The trial was laid out during Rabi season in Randomized Block Design (RBD) with six treatments including untreated control, replicated four times. For each treatment, plot size of 40 sq. m (8 m×5 m) was maintained. The Tomato crop in the trial field was raised following good agricultural practices. The seeds of Tomato, Namdhari 1068, were used for the study and planted in 120 cm row to row and 45 cm plant to plant spacing. The details of the experiment are as follows:

| | |
|---|---|
| Trial location | Manchar (MH) |
| Crop: | Tomato (variety Namdhari 1068) |
| Experiment season | Rabi |
| Trial Design | Randomized Block Design |
| Replications | Four |
| Plot size | 8 m × 5 m = 40 sq. m |
| Type of application | Broadcasting in furrow |
| Date of transplanting | 12 Jan. 2023 |
| Date of application | 23 Jan. 2023 (one application) |
| Date of Pickings | 1 May 2023, 11 May 2023, 16 May 2023 |

The plant vigor observations were taken at 50 days after application at 0-200% rating scale where UTC (untreated control) should be always 1000. The fruits were harvested three times and weighed each time and mean data is presented in Table 6. Herein the inventor has tested composition comprising combination of elemental sulphur, water insoluble zinc and selenium as per the embodiment of the present invention as compared to market standard, Yaramila fertilizer product (comprising Nitrogen 20%+P2O5−4.5%+20 7.5+Se 0.0015%) and traditional farmer practice (NPK) and the mean data of all the observations were presented in Table 6 to illustrate the impact of combination of elemental sulphur, water insoluble zinc and selenium as per the embodiment of the present invention on Tomato yield, plant vigor and other parameters.

TABLE 6

| | | | | | Observations | | |
|---|---|---|---|---|---|---|---|
| | | | | | Plant | Yield | |
| | | Active dosage | | | vigor | (T/ha) | % |
| Sr. | Treatment | (Elemental) (g/ha) | | | (0-200) | Total of | yield |
| No. | Details | S | Zn | Se | at 50 DAA | 3 pickings | increase |
| T1 | Sulphur 20% + | 20000 | 1450 | 120 | 146 | 8.9 | 30.88 |
| | Zinc molybdate | | | | | | |
| | 5% (Zn 1.45%) + | | | | | | |
| | Potassium | | | | | | |
| | selenite 0.3% | | | | | | |
| | (Se 0.12%) SC | | | | | | |
| | as per | | | | | | |
| | embodiment of | | | | | | |
| | the present | | | | | | |
| | invention @ | | | | | | |
| | 100000 g/ha | | | | | | |
| T2 | Sulphur 50% + | 5500 | 1606 | 783 | 139 | 8.1 | 19.12 |
| | Zinc carbonate | | | | | | |
| | 28% (Zn | | | | | | |
| | 14.6%) + | | | | | | |
| | Selenium | | | | | | |
| | dioxide 10% | | | | | | |
| | (Se 7.12%) GR | | | | | | |
| | as per | | | | | | |
| | embodiment of | | | | | | |
| | the present | | | | | | |
| | invention | | | | | | |
| | @11000 g/ha | | | | | | |
| T3 | Sulphur 45% + | 6750 | 4217 | 427 | 140 | 8.4 | 23.53 |
| | Zinc Oxide | | | | | | |
| | 35% (Zn | | | | | | |
| | 28.11%) + | | | | | | |
| | Selenium | | | | | | |
| | dioxide 4% (Se | | | | | | |
| | 2.85%) WDG | | | | | | |
| | as per | | | | | | |
| | embodiment of | | | | | | |
| | the present | | | | | | |
| | invention | | | | | | |
| | @15000 g/ha | | | | | | |
| T4 | Market | — | — | — | 128 | 7.7 | 13.24 |
| | standard | | | | | | |
| | (Yaramila) | | | | | | |
| | @225000 g/ha | | | | | | |
| T5 | Farmer practice | — | — | — | 120 | 7.5 | 10.29 |
| | (NPK) | | | | | | |
| | @125000 g/ha | | | | | | |
| | in 3 split | | | | | | |
| | applications | | | | | | |
| T6 | Untreated | 0 | 0 | 0 | 100 | 6.8 | 0.00 |
| | Control | | | | | | |

From the data presented in the Table 6, it can be seen that the treatments T1 to T3 with the compositions as per the embodiments of the present invention comprising combination of elemental sulphur, water insoluble zinc and selenium in granular and aqueous suspension form at various concentrations demonstrated superior efficacy in terms of improved plant vigor and higher yield as compared to market standard (Yaramila) as well as traditional fertilizer practice (NPK) even at reduced dosage of application.

The surprising synergistic result of treatments T1 to T3 is attributed to the composition comprising homogenous mixture of elemental sulphur, water insoluble zinc and selenium as per the embodiments of the invention, where all three nutrients are present in a single composition at a specific concentration, specific particle size and the form of the composition in WDG, GR and SC form.

Field trial 7: To assess the efficacy of different formulations of elemental sulphur, water insoluble zinc and selenium in comparison to combination of selenium with water-soluble source of zinc and sulphur in sulfate form in Tomato:

The trial was laid out during Kharif season in Randomized Block Design (RBD) with nine treatments including untreated control, replicated four times. For each treatment, plot size of 40 sq. m (8 m×5 m) was maintained. The Tomato crop in the trial field was raised following good agricultural practices. The seeds of Tomato, Ayaan, were used for the study and planted in 120 cm row to row and 45 cm plant to plant spacing. The details of the experiment are as follows:

| | |
|---|---|
| Trial location | Dehgam (Gujarat) |
| Crop: | Tomato (variety Ayaan) |
| Experiment season | Kharif |
| Trial Design | Randomized Block Design |
| Replications | Four |
| Plot size | 8 m × 5 m = 40 sq. m |
| Type of application | Basal application |
| Date of transplanting | 12 Jul. 2022 |
| Date of application | 12 Jul. 2022 (one application) |
| Date of Pickings | 20 Oct. 2022, 30 Oct. 2022, 4 Nov. 2022 |

The observations on number of branches were carried out at 50 days after application from 10 randomly selected plants per treatment per replication and mean value was calculated. The plant vigor observations were taken at 50 days after application at 0-200% rating scale where UTC (untreated control) should be always 100%. The fruits were harvested three times and weighed each time and mean data is presented in Table 7.

Herein the inventor has tested composition comprising combination of elemental sulphur, water insoluble zinc and selenium as per the embodiment of the present invention as compared to compositions having sulphur in sulphate form i.e. calcium sulphate or ammonium sulphate and water soluble zinc salt i.e. zinc sulphate and the mean data of all the observations were presented in Table 7 to illustrate the impact of combination of elemental sulphur, water insoluble zinc and selenium as per the embodiment of the present invention on Tomato yield, plant vigor and other parameters.

TABLE 7

| | | | | | Avrage | | | |
|---|---|---|---|---|---|---|---|---|
| | | | | | No of | Plant | Yield | |
| | | Active dosage | | | branches/ | vigor | (T/ha) | % |
| Sr. | | (Elemental) (g/ha) | | | plant | (0-200) | Total of | yield |
| no. | Treatment details | S | Zn | Se | 50 DAA | 50 DAA | 3 pickings | increase |
| T1 | Elemental Sulphur | 16000 | 1280 | 228 | 14 | 142 | 10.1 | 38.36 |
| | 75% + Zinc oxide | | | | | | | |
| | 7.5% (Zn 6%) + | | | | | | | |
| | Potassium Selenate | | | | | | | |
| | 3% (Se 1.07%) | | | | | | | |
| | WDG as per | | | | | | | |
| | embodiment of the | | | | | | | |
| | present invention | | | | | | | |
| | @21333 g/ha | | | | | | | |
| T2 | Elemental sulphur | 16000 | 1285 | 228 | 10 | 128 | 8.4 | 15.07 |
| | 75% + Zinc Sulphate | | | | | | | |
| | 16.5% (Zn 6.02%) + | | | | | | | |
| | Potassium Selenate | | | | | | | |
| | 3% (Se 1.07%) | | | | | | | |
| | granules @21333 | | | | | | | |
| | g/ha | | | | | | | |
| T3 | Ammonium | 16000 | 1283 | 229 | 10 | 126 | 8 | 9.59 |
| | Sulphate 80% (S | | | | | | | |
| | 19.2%) + Zinc oxide | | | | | | | |
| | 1.92% (Zn 1.54%) + | | | | | | | |
| | Potassium Selenate | | | | | | | |
| | 0.77% (Se 0.275%) | | | | | | | |
| | granules @83333 | | | | | | | |
| | g/ha | | | | | | | |
| T4 | Ammonium | 16000 | 1283 | 229 | 9 | 120 | 7.8 | 6.85 |
| | Sulphate 80% (S | | | | | | | |
| | 19.2%) + Zinc | | | | | | | |
| | Sulphate 4.23% (Zn | | | | | | | |
| | 1.54%) + Potassium | | | | | | | |
| | Selenate 0.77% (Se | | | | | | | |
| | 0.275%) granules | | | | | | | |
| | @83333 g/ha | | | | | | | |
| T5 | Elemental Sulphur | 8000 | 1288 | 796 | 12 | 135 | 9.8 | 34.25 |
| | 20% + Zinc | | | | | | | |
| | molybdate 11.1% | | | | | | | |
| | (Zn 3.22%) + | | | | | | | |
| | Potassium selenate | | | | | | | |
| | 5.57% (Se 1.99%) | | | | | | | |
| | SC as per | | | | | | | |
| | embodiment of the | | | | | | | |
| | present invention | | | | | | | |
| | @40000 g/ha | | | | | | | |
| T6 | Elemental Sulphur | 8000 | 1180 | 820 | 12 | 133 | 8.9 | 21.92 |
| | 20% + Zinc Selenite | | | | | | | |
| | 5% (Zn 2.95%, Se | | | | | | | |
| | 2.05%) WDG as per | | | | | | | |
| | embodiment of the | | | | | | | |
| | present invention | | | | | | | |
| | @40000 g/ha | | | | | | | |
| T7 | Calcium sulphate | 8460 | 1328 | 923 | 9 | 121 | 8 | 9.59 |
| | 80% (S 18.8%) + | | | | | | | |
| | Zinc Selenite 5% | | | | | | | |
| | (Zn 2.95%, Se | | | | | | | |
| | 2.05%) | | | | | | | |
| | (corresponding | | | | | | | |
| | sample of Silica | | | | | | | |
| | coated Granule as | | | | | | | |
| | per CN109453736) | | | | | | | |
| | @45000 g/ha | | | | | | | |
| T8 | Farmer Practice | 0 | 0 | 195 | 9 | 120 | 7.8 | 6.85 |
| | (NPK) @125000 | | | | | | | |
| | g/ha in 3 split | | | | | | | |
| | applications | | | | | | | |
| T9 | Untreated | 0 | 0 | 0 | 8 | 100 | 7.3 | 0.00 |

It can be seen from the data presented in Table 7 that treatments with the compositions of the present invention i.e. T1, T5 and T6 comprising elemental sulphur, water insoluble zinc and selenium in the form of a water dispersible granule and an aqueous suspension illustrated significant increase in plant vigor, yield etc. in tomato crop as compared to other treatments i.e. T2, T3, T4 and T7. In particular, upon comparing T1 with that of T2 to T4 which were applied at almost same dosage of sulphur, zinc and selenium, the treatment T1 with elemental sulphur, water insoluble Zn salt and selenium in WG form as per the embodiment of the present invention showed enhanced yield of around 38.36% while treatment T2 with granular composition comprising combination of elemental sulphur, water soluble zinc salt (zinc sulphate) and selenium, treatment T3 with granular composition comprising sulphur in sulphate from (i.e. ammonium sulphate), water insoluble zinc and selenium and treatment T4 with the water soluble sulphur salt (ammonium sulphate), water soluble zinc salt (zinc sulphate) and selenium showed a yield increase of around 6% to 15%.

This unexpected and surprising increase in yield was on account of the combination of elemental sulphur, water insoluble zinc salt and selenium and was not observed with other combinations i.e. compositions comprising either water soluble sulphur salt or water soluble zinc salt or both sulphur and zinc in water soluble form. The same trend was observed in case of plant vigor and other growth parameters such as fruit weight, number of branches, number of flowers, etc.

In addition, treatments T5 and T6 with an aqueous suspension and water dispersible granular formulation as per the embodiment of the present invention comprising a combination of elemental sulphur, water insoluble zinc salt and selenium illustrated a yield increase of 34.25% and 21.92% respectively over untreated control when compared to the treatment T7 with the silica coated granules prepared as per the teaching of CN'736 comprising sulphur in sulphate form (i.e. calcium sulphate) which showed yield increase of only 9.59% as compared to untreated. The yield increase was more surprising since the treatments T5 and T6 were applied at lower dosage of actives as compared to prior art composition (T7). The similar improvement was also observed in case of plant growth parameters such as fruit weight, number of branches, number of flowers, plant vigor etc.

The superior effect of the present composition is on account of elements being a homogeneous mixture of elemental sulphur, water insoluble zinc and selenium in granular and aqueous suspension form and in specific particle size of 0.1-30 microns.

The inventor surprisingly found that the present invention does not merely lie in a combination of sulphur, zinc and selenium but also in the identification of a particular combination of elemental sulphur with water insoluble zinc salt and selenium salt formulated in water dispersible granular or an aqueous suspension composition with an identification of specific particle size of 0.1-30 microns.

Further, the inventor of the present invention also tested the granular and aqueous suspension composition of the present invention on other crops like chilli, wheat etc. It was observed that the composition of the present invention demonstrated enhanced crop yield and crop characteristics like straw weight, greenness of crop, plant height, fruit weight, improved photosynthesis, increased stress resistance and also added to the nutritional value of the crop.

It has been observed that the composition of the present invention demonstrates enhanced, efficacious and superior behavior in the fields. Through the composition of the present invention, the number of applications or the amount of nutrients, fertilizers or pesticides are minimized. Moreover, the present composition exhibits a surprisingly higher field efficacy at reduced dosages of application of the composition as compared to prior known composition. The composition is highly safe for the user as well as the environment and do not show any phytotoxicity. This novel composition helps to improve plant yield, balanced uptake of all nutrients, reduce yellowing of leaves and improved plant physiological parameters providing a nutritionally rich crop.

Further, the various advantageous properties associated with the compositions according to the invention, include but are not limited to improved stability, improved toxicological and/or ecotoxicological behavior, improved crop characteristics including crop yields, crop qualities and characteristics and other advantages familiar to a person skilled in the art.

From the foregoing, it will be observed that numerous modifications and variations is effectuated without departing from the true spirit and scope of the novel concepts of the present invention. It is to be understood that no limitation with respect to the specific embodiments illustrated is intended or should be inferred.

I claim:

1. A crop nutrition and fortification composition comprising of:
i. elemental sulphur in the range of 1% to 90% by weight of the total composition;
ii. one or more of water insoluble zinc salts, complexes or derivatives thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. at least one surfactant in the range of 0.1% to 40% by weight of total composition;
wherein the composition comprises particles in the size range of 0.1 micron to 30 microns; and
wherein the composition is in the form of granules or aqueous suspension.

2. The crop nutrition and fortification composition as claimed in claim 1, wherein the water insoluble zinc salt, derivative or complex is selected from one or more of zinc oxide, zinc carbonate, zinc sulphide, zinc molybdate, zinc phosphate, zinc borate, zinc silicate, zinc pyrophosphate, zinc citrate, ashoverite, sphalerite, smithsonite, and wurtzite.

3. The crop nutrition and fortification composition as claimed in claim 1, wherein the selenium salt, derivative or complex is selected from one or more of selenium, selenium carbonates, vanadium selenide, magnesium selenide, manganese selenide, selenium sulphide, copper selenide, iron selenide, molybdenum selenide, cobalt selenide, bismuth selenide, zinc selenide, copper selenite, calcium selenite, magnesium selenite, manganese selenite, cobalt selenite, selenium dioxide, selenourea, sodium selenide, potassium selenide, copper selenide, ammonium selenide, sodium selenite, potassium selenite, ammonium selenite, iron selenite, zinc selenite, sodium selenate, magnesium selenate, potassium selenate, calcium selenate, copper selenate, ammonium selenate, iron selenate, cobalt selenite, zinc selenate selenium sulfide, selenious acid and selenium yeast.

4. The crop nutrition and fortification composition as claimed in claim 1, wherein the surfactant is selected from nonionic or anionic surfactant or mixture thereof.

5. The crop nutrition and fortification composition as claimed in claim 1, wherein the surfactant comprises one or more of emulsifiers, wetting agents and dispersing agents.

6. The crop nutrition and fortification composition as claimed in claim 5, wherein the dispersing agent is a non-ionic dispersant selected from one or more of polyvinyl pyrrolidone, polyvinyl alcohol, polyoxyethylene alkyl ethers, polyoxyethylene alkyl phenyl ether, ethoxylated fatty acids, aliphatic alcohol ethoxylates, alkyl ethoxylates; EO-PO block copolymers, graft copolymers, addition products of ethylene oxide and fatty acid esters, Kraft lignin polymer, polyoxyethylene alkyl esters, polyoxyethylenesorbitan alkyl esters, ethoxylated alkyl phenols, polyoxyethylenestyryl phenyl ether.

7. The crop nutrition and fortification composition as claimed in claim 5, wherein the dispersing agent is anionic dispersants selected from one or more of sulfated fatty alcohol glyscol ethers, tristyrylphenolethoxylate phosphate esters; lignin sulphonates, phenyl naphthalene sulphonates, alkali metal, alkaline earth metal and ammonium salts of lignosulfonic acid, lignin derivatives, alkylarylsulfonates, alkylsulfonates, mixture of sodium salt of naphthalene sulphonic acid urea formaldehyde condensate and sodium salt of phenol sulphonic formaldehyde condensate, polycarboxylates, sodium alkyl benzene sulfonates, sodium salts of sulfonated naphthalene, sodium naphthalene sulfonate formaldehyde condensates, condensation products of aryl sulphonic acids and formaldehyde, polyaromatic sulfonates, sodium alkyl aryl sulfonate.

8. The crop nutrition and fortification composition as claimed in claim 1, further comprises at least one agrochemically acceptable excipient selected from one or more of fillers or carriers or diluents, disintegrating agents, spreading agents, structuring agents, colorants, anticaking agents, binders, buffers or pH adjusters or neutralizing agents, tackifiers, pigments, stabilizers, antifoaming agents or defoamers, anti-settling agents, penetrants, preservatives, humectants, sticking agents, anti-freezing agent or freeze point depressants, chelating or complexing or sequestering agents.

9. The crop nutrition and fortification composition as claimed in claim 1, wherein the granules of the composition are in the size range of 0.05 mm to 6.0 mm.

10. The crop nutrition and fortification composition as claimed in claim 1, wherein the granules are in the form of or water disintegrable granules.

11. The crop nutrition and fortification composition as claimed in claim 1, wherein the granules are in the form of water dispersible granules.

12. The crop nutrition and fortification composition in the form of water dispersible granules as claimed in claim 11, wherein the granules are in the size range of 0.05 mm to 4 mm.

13. The crop nutrition and fortification composition in the form of water dispersible granules as claimed in claim 11, wherein the water dispersible granular composition has a dispersibility of at least 30%.

14. The crop nutrition and fortification composition as claimed in claim 11, wherein the composition has D50 of less than 5 microns and D90 of less than 10 microns.

15. The crop nutrition and fortification composition as claimed in claim 1, wherein the composition is in the form of aqueous suspension.

16. The crop nutrition and fortification composition as claimed in claim 1, wherein aqueous suspension composition further comprises structuring agents selected from one or more of thickeners, suspending agents or suspension aid agents, viscosity modifiers or rheology modifiers, tackifiers, anti-settling agents.

17. The crop nutrition and fortification composition as claimed in claim 16, wherein the structuring agents is present in the range of 0.01% to 10% by weight of the total composition.

18. The crop nutrition and fortification composition as claimed in claim 1, wherein the aqueous suspension composition has a pourability of less than 5% rinsed residue.

19. The crop nutrition and fortification composition as claimed in claim 1, wherein the aqueous suspension composition has a viscosity of 150 cps to 2000 cps at 25° C.

20. A process for preparation of crop nutrition and fortification composition in the form of water disintegrable granules as claimed in claim 1, wherein the process comprises:
a. Milling:
i. elemental sulphur in the range of 1% to 90% by weight of the total composition;
ii. one or more of water insoluble zinc salts, complexes or derivatives thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. one or more of surfactant in the range of 0.10% to 40% by weight of the total composition to obtain a powder with the particles in the size range of 0.1 micron to 30 microns,
b. Adding water to the powder obtained in step (a) to prepare a dough,
c. Granulating a dough and drying to obtain water disintegrable granular composition in a size range of 0.1 mm to 6 mm.

21. A process for preparation of crop nutrition and fortification composition in the form of water dispersible granules as claimed in claim 1, wherein the process comprises:
a. Milling:
i. elemental sulphur in the range of 1% to 90% by weight of the total composition;
ii. one or more of water insoluble zinc salts, complex or derivative thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. one or more of surfactant in the range of 0.1% to 40% by weight of the total composition, in water to obtain a slurry or wet mix, wherein the particles are in the size range of 0.1 micron to 30 microns,
b. drying the slurry or wet mix to obtain the granules in the size range of 0.05 mm to 4 mm.

22. A process for preparation of crop nutrition and fortification composition in the form of aqueous suspension as claimed in claim 1, wherein the process comprises:
a. milling:
i. elemental sulphur in the range of 1% w/w to 70% w/w of the total composition;
ii. one or more of water insoluble zinc salts, complex or derivative thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. one or more of surfactant in the range of 0.10% to 40% by weight of the total composition, in water to obtain a homogeneous suspension, wherein the particles are in the size range of 0.1 micron to 30 microns
b. adding structuring agent and further excipients, if required and balance water to obtain the aqueous suspension.

23. A method for enhancing the nutrient uptake and improving plant health and yield, said method comprising treatment of plant, a plant propagation material, locus or plant parts thereof, a seed, seedling or surrounding soil with the crop nutrition and fortification composition comprising a homogeneous mixture of:
i. elemental sulphur in the range of 1% to 90% by weight of the total composition;
ii. one or more of water insoluble zinc salts, complex or derivative thereof wherein the elemental zinc content is in the range of 0.1% to 50% by weight of the total composition;
iii. elemental selenium or its salts, complexes, derivatives or mixture thereof wherein the elemental selenium content is in the range of 0.001% to 10% by weight of the total composition; and
iv. at least one surfactant in the range of 0.1% to 40% by weight of total composition;
wherein the composition comprises particles in the size range of 0.1 micron to 30 microns; and
wherein the composition is in the form of granules or aqueous suspension.
